(19) United States
(12) Patent Application Publication
(10) Pub. No.: US 2007/0088630 A1
(43) Pub. Date: Apr. 19, 2007

(54) Assessment and/or deployment of computer network component(s)

(75) Inventors: Stewart P. MacLeod, Woodinville, WA (US); Felix W. Wong, Bellevue, WA (US); Joseph Coulombe, Woodinville, WA (US); Perry J. Owen, Woodinville, WA (US); Osman Mohiuddin, Redmond, WA (US); Kalpesh S. Patel, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/238,707

(22) Filed: Sep. 29, 2005

(51) Int. Cl. G06Q 10/00

(52) U.S. Cl. 705/28

(57) ABSTRACT

A system and method that facilitates automated assessment and/or deployment related to computer network(s) is provided. The assessment system can be employed to automatically discover network asset(s) and inventory the discovered asset(s) (e.g., hardware and/or software). The deployment system can utilize the inventory to (1) create diagram(s) of the network asset(s) and/or proposed infrastructure; (2) create a customized, detailed proposal to upgrade and/or migrate existing infrastructure; (3) create checklist(s) and/or job aids to facilitate upgrade and/or migration; (4) automate setup of the network infrastructure, (5) identify hardware and/or software compatibility issue(s), if any; and/or (6) prepare a software license summary. For example, the system and method can be employed to quickly provide information to business decision makers to facilitate the decision-making process with regard to migration of the computer network infrastructure.

### BACKGROUND

Computer networks exist in a variety of environments, for example, enterprise, medium and business environments. Each of these environments has very different requirements and expectations. Further, as additional hardware component(s) and/or software component(s) are added to a particular network, maintenance requirements are increased. Further complicating matters, computers on the network can be running various operating systems with different processor capabilities.

For example, a particular computer network can have numerous computers equipped with varying processors and processor speeds. Each of the computers can be running a particular version of an operating system and particular versions of various software application(s). The permutations of hardware components and software components can lead an unwieldy and complex matrix for even the most seasoned IT professional to comprehend. Many environments have failed to upgrade/migrate their hardware, operating system(s) and/or application software due to the cost and effort required to identify the appropriate hardware/software to facilitate the upgrade/migration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method that facilitates automated assessment and/or deployment related to computer network(s) is provided. With respect to assessment, the system and method can be employed to automatically discover network asset(s) and then inventory component(s) (e.g., hardware and/or software) of the discovered network asset(s).

Optionally, the system and method can facilitate deployment of component(s) (e.g., hardware and/or software) including: (1) creation of diagram(s) of the network asset(s) and/or proposed infrastructure; (2) creation of a customized, detailed proposal to upgrade and/or migrate existing infrastructure; (3) creation of checklist(s) and/or job aids to facilitate upgrade and/or migration; (4) automate setup of the network infrastructure, (5) identification of hardware and/or software compatibility issue(s), if any; and/or (6) preparation of a software license summary. For example, with regard to deployment, the system and method can be employed to quickly provide information to business decision makers to facilitate the decision-making process with regard to migration of the computer network infrastructure.

In one aspect, an automated network assessment system comprising an inventory collection component that discovers item(s) on the network is provided. At least some of the discovered information can then be stored in an inventory data store (e.g., database). The inventory collection component can then inventory component(s) (e.g., hardware and/or software) of the discovered network item(s). The inventory information can also be stored in the inventory data store.

For example, the automated network assessment system can be employed by an IT professional to quickly create a detailed accurate inventory of desktop computers, mobile devices, servers, network infrastructure etc. that have been deployed in a customer's environment. This can include a detailed hardware and software inventory. As such, customers are not required to deploy an agent and/or management infrastructure to facilitate collection of the inventory.

Optionally, the inventory collection component can include one or more inventory collectors, each inventory collector obtains detailed information associated with component(s) in a particular manner (e.g., using Win32®, Windows® Management Instrumentation (WMI), Active Directory® (AD), LanManager API, Service Control Manager and/or Simple Network Management Protocol (SNMP)). For example, the inventory collection component can remotely connect to computer(s) using remote procedure call (RPC), distributed component object model (DCOM) and/or Lightweight Directory Access Protocol (LDAP).

With respect to computer(s) employing a legacy platform that does not support RPC, DCOM and/or WMI, if inventory information is required for the computer, an inventory collector for the particular legacy platform can be employed on the particular computer and a central file share created. The legacy inventory collector can return a subset of information (e.g., using an operating system API and the system registry) which can be stored to a network share where it can be imported into the inventory data store. For example, the system can include an inventory wizard (e.g., user interface) that can be employed to specify the information a user, for example, an IT professional, desires the system to collect.

Optionally, the system can be employed to facilitate deployment of component(s) (e.g., hardware and/or software) and can further include a project proposal wizard, a detailed project plan, diagram(s), checklist(s), an automated deployment component, a server reporting tool and/or a compatibility component. The project proposal wizard can be employed to facilitate generation of a detailed draft proposal that the IT professional can present to a customer for consideration. For example, the draft proposal can include information regarding upgrades of server(s) and/or particular workstations.

The project proposal summarizes the work (e.g., to be covered in a bid). Proposals can include, for example:
1. Migration from one server operating system to another;
2. Upgrading of software application(s);
3. Installation and configuration of virtual private network (YPN)/Connected User Scenarios;
4. Installation and configuration of health monitoring software;
5. Installation and configuration of update services (client patching); and/or
6. Active Directory® Group Policy (Configuration and Software Distribution)

The detailed project plan can be generated by the system and can further reduce the time on-site required by the IT professional. The detailed project plan can proactively identify known compatibility problem(s), if any, and recommended remediation before upgrade/migration commences. For example, the project plan can include a list of the software to be installed and all of the configurations selected. The scope of the project plan can be based on the project proposal wizard.

The detailed inventory and proposal information in the inventory data store can be employed to automatically generate diagram(s) that summarize the current and/or proposed architecture. These diagram(s) can make it easy for both the IT professional and the customer to understand exactly what has been deployed in production.

The proposal generated by the system can include detailed checklist(s) that can be used, for example, by less experienced consultants. The checklist(s) can provide details of an upgrade/migration plan that specifically describes the location of each service and steps required to complete the upgrade/migration. The checklists can include a list of the tasks with finish start relationships based on success which reduces the number of items. The checklist(s) and other aids can be customized to the specific environment. For example, the actual computer names and IP addresses can be used in these documents, not just generic values. Furthermore, the sections of the document can change depending on the specific environment, so if a customer is doing a specific type of migration of a system, then the documents only describe the steps for doing that type of migration, and no other types.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of an automated network assessment system.

FIG. 2 is a block diagram of an inventory collection component.

FIG. 3 is a diagram of an exemplary data store.

FIG. 4 is a screen shot of a user interface of initiation of an inventory wizard.

FIG. 5 is a screen shot of a user interface regarding network information to be included in the inventory.

FIG. 6 is a screen shot of a user interface that facilitates identification/selection of components.

FIG. 7 is a screen shot of a user interface regarding the use of SNMP information.

FIG. 8 is a screen shot of a user interface of WMI hardware and software inventory to be collected.

FIG. 9 is a screen shot of a user interface facilitating information for use by the inventory collection system for storing the inventory data store.

FIG. 10 is a screen shot of a user interface of completion of the inventory wizard.

FIG. 11 is a block diagram of an automated network deployment system.

FIG. 12 is a screen shot of a user interface of a welcome screen of a proposal wizard.

FIG. 13 is a screen shot of a user interface facilitating identification of information to be employed in generating a proposal.

FIG. 14 is a screen shot of a user interface regarding the project scope to be employed in generation of the proposal.

FIG. 15 is a screen shot of a user interface that facilitates identification of servers to be included in the proposal.

FIG. 16 is a screen shot of a user interface employed to identify client workstation project scope.

FIG. 17 is a screen shot of a user interface facilitating identification of server role assignments.

FIG. 18 is a screen shot of a user interface facilitating identification of information to be included in the proposal.

FIG. 19 is a screen shot of a user interface facilitating identification of details for the proposal.

FIG. 20 is a screen shot of a user interface presented while the proposal is being generated.

FIG. 21 is a screen shot of a user interface employed for proposal completion.

FIG. 22 is an exemplary diagram.

FIG. 23 is a task flow diagram.

FIG. 24 is a diagram of an exemplary schema with respect to workflow.

FIG. 25 an example output of execution of a workflow script.

FIG. 26 is a screen shot of a user interface of initiation of a deployment wizard.

FIG. 27 is a screen shot of a user interface of a user interface regarding domain administrator credentials.

FIG. 28 is a screen shot of a user interface of a user interface regarding domain administrator credentials for a new domain.

FIG. 29 is a screen shot of a user interface regarding directory services restore mode password.

FIG. 30 is a screen shot of a user interface facilitating entry of operations manager credentials

FIG. 31 is a screen shot of a user interface regarding Management Server Administrative Password.

FIG. 32 is a screen shot of a user interface indicating that the system is ready to deploy servers.

FIG. 33 is a screen shot of a user interface that facilitates communication with a user during the deployment process.

FIG. 34 is a flow chart of a method of method of collecting inventory information.

FIG. 35 is a flow chart of a method of generating proposal information.

FIG. 36 illustrates an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model, ” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

Systems and methods that facilitate automated assessment and/or deployment related to computer network(s) is provided. The systems and methods can be employed to: (1) automatically discover network asset(s) and create an inventory of the discovered network asset(s); (2) create diagram(s) of the network asset(s) and/or proposed infrastructure; (3) create a customized, detailed proposal to upgrade and/or migrate existing infrastructure; (4) create checklist(s) and/or job aids to facilitate upgrade and/or migration; (5) automate setup of the network infrastructure, (6) identify hardware and/or software compatibility issue(s), if any; and/or (7) prepare a software license summary. For example, the system and method can be employed to quickly provide information to business decision makers to facilitate the decision-making process with regard to migration of the computer network infrastructure. Automated Network Assessment

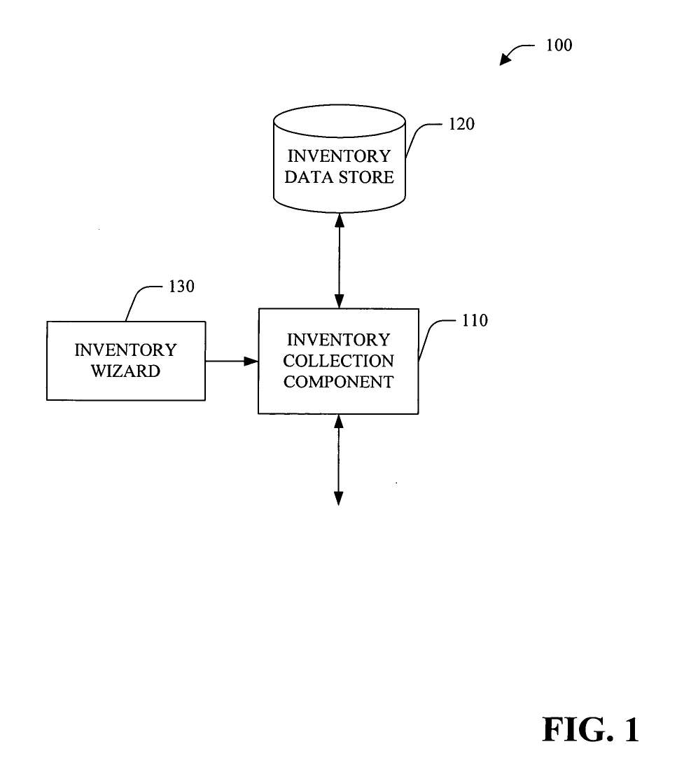

Referring to FIG. 1, an automated network assessment system 100 is illustrated. The automated network discovery system 100 can receive information via a computer network to identify hardware and/or software component(s) connected to the network. For example, the automated network discovery system 100 can be installed on an IT professional's laptop connected to a customer's network and/or installed on a computer connected to a customer's network. The automated network discovery system 100 can identify hardware component(s) and/or software component(s) of computer(s) on the network.

The automated network discovery system 100 can include an inventory collection component 110 that discovers hardware and/or software component(s) on the network. At least some of the discovered information can then be stored in an inventory data store 120 (e.g., database). For example, the automated network discovery system 100 can be employed by an IT professional to quickly create a detailed accurate inventory of desktop computers, mobile devices, servers, network infrastructure etc. that have been deployed in a customer's environment. This can include a detailed hardware and software inventory. As such, customers are not required to deploy an agent and/or management infrastructure to facilitate collection of the inventory.

For example, an IT professional can be retained to prepare a detailed proposal for a customer to upgrade their IT infrastructure. Conventionally, it can take a significant period of time (e.g., eight to twelve hours) and significant effort for the IT professional to prepare a detailed inventory of the customer's IT infrastructure. Additionally, the IT professional can require the assistance of a person from the customer's IT staff. The IT professional can employ the automated network discovery system 100 to quickly identify server(s), workstation(s), network device(s) etc. and create a detailed hardware and software inventory. The system 100 can further locate file shares and domain controllers. The system 100 can further, optionally, prepare a report that summarizes software component(s) installed on these various elements of the network.

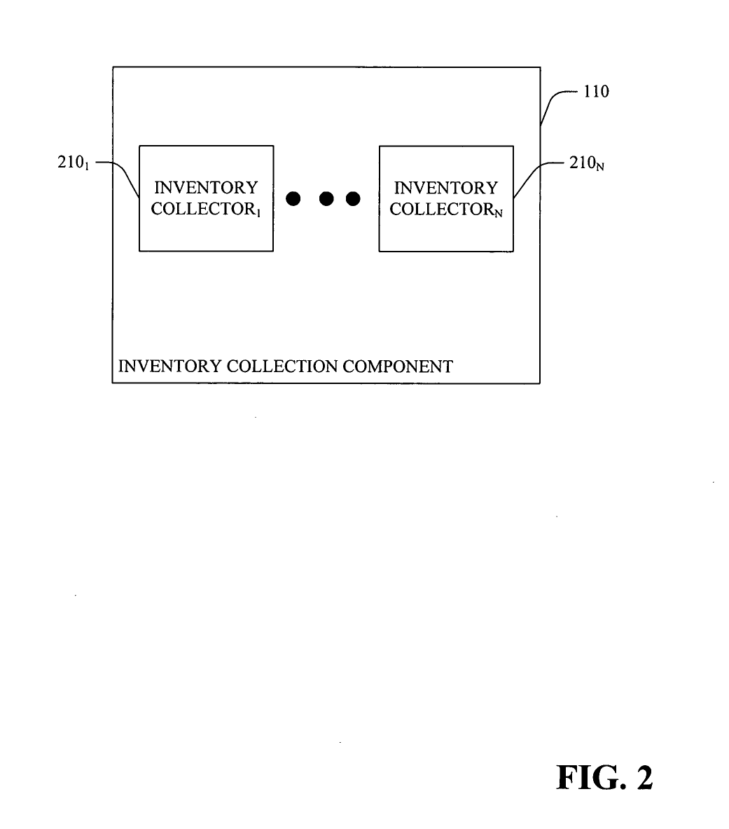

Turning to FIG. 2, an inventory collection component 110 is illustrated. The inventory collection component 110 includes one or more inventory collectors 210, each inventory collector 210 discovers detailed information associated with hardware component(s) and/or software component(s) in a particular manner (e.g., using Win32®, Windows® Management Information (WMI), Active Directory® (AD), LanManager API, Service Control Manager and/or Simple Network Management Protocol (SNMP)), as discussed below. For example, the inventory collection component 110 can remotely connect to computer(s) using remote procedure call (RPC), distributed component object model (DCOM) and/or Lightweight Directory Access Protocol (LDAP).

Optionally, the data to be collected can be specified using an inventory wizard 130 (e.g., user interface), as discussed below. The data collected via the inventory collector(s) 220 can be stored in the inventory data store 120.

With respect to computer(s) employing a legacy platform that does not support RPC, DCOM and/or WMI, if inventory information is required for the computer, an inventory collector 210 for the particular legacy platform can be employed on the particular computer and a central file share created. The legacy inventory collector 210 can return a subset of information (e.g., using an operating system API and the system registry) which can be stored to a network share where it can be imported into the inventory data store 120. The information can include, for example:
Computer Name
IP Address
CPU Type
CPU Count
Domain information
Drive Capacity
Drive Free Space
Operating System Version
Page File

Next, a particular inventory collector 210 can be associated with Win32®, for example, using the Win32® API NetServerEnum( ) to identify Windows® servers and/or laptops identified on the network. Additionally, Win32® APIs can be employed to check for Active Directory®, Domains and clustering. Information can further be read from the registry using standard APIs. In addition, network configuration information can be read from the Domain Name Service (DNS), Dynamic Host Configuration Protocol (DHCP) and/or Windows® Internet Naming Service (WINS).

Continuing with this example, certain information can be collected from Win32 APIs directly. For example, the NetServerEnum( ) API can be used to detect Win32 machines that are currently on the network; however, it does not detect machines that are not currently attached to the network. In this example, the following information can be collected from Win32:

TABLE 1

| Win32 API | Description |
|---|---|
| NetServerEnum( ) | The NetServerEnum( ) function lists |
| | server(s) of the specified type that are |
| | visible in a domain |
| IClusCfgClusterInfo | Cluster configuration information |
| GetDomaim( ) | DNS/AD domain information |

Further, Active Directory®, if present, can provide some information about devices that are not connected to the network at the time that the network inventory is performed.

In another example, a particular inventory collector 210 can be associated with WMI to obtain a detailed hardware and software inventory and operating system configuration information from each computer on which it has permissions. This includes information, for example, about local account(s), BIOS, disk drives, memory, processor information, software inventory, network configuration and/or software patch(es) etc.

In this example, the inventory collector 210 can leverage C# and the .NET System. SystemManagement namespace to remotely read WMI information. For example, inventory information can be collected from the following WMI classes. The following WMI classes are merely examples of classes from which inventory information can be collected—additional inventory information can be collected from other WMI classes.

TABLE 2

| WMI Class | Description |
|---|---|
| Win32_Account | Local Accounts |
| Win32_BIOS | BIOS Information |
| Win32_CDROMDrive | CD-ROM Drive Information |
| Win32_ComputerSystem | Computer System Information |
| Win32_DesktopMonitor | Desktop Monitor Information |
| Win32_DiskDrive | Disk Drive Vendor, And |
| | Capacity |
| Win32_DiskPartition | Disk Partition Information |
| Win32_FloppyDrive | Floppy Drive Information |
| Win32_InfraredDevice | Infrared Device Information |
| Win32_Keyboard | Keyboard Information |
| Win32_LogicalDisk | Logical Disk Information |
| Win32_LogicalMemoryConfiguration | Memory Configuration |
| Win32_MotherboardDevice | Motherboard Device Information |
| Win32_NetworkAdapter | Network Adapter Information |
| Win32_NetworkAdapterConfiguration | Network Adapter Configuration |
| | Settings |
| Win32_NTDomain | NT Domain Information |
| Win32_OperatingSystem | Windows Operating System |
| | Information |
| Win32_ParallelPort | Parallel Port Information |
| Win32_Patch | Installed Patches |
| Win32_PatchFile | Patch File Information |
| Win32_PointingDevice | Mouse Information |
| Win32_POTSModem | Modem Information |
| Win32_Printer | Printer Information |
| Win32_PrinterShare | Printer Share Information |
| Win32_Processor | CPU Information |
| Win32_Product | Installed Software |
| Win32_QuickFixEngineering | patches |
| Win32_SCSIController | SCSI Controller Information |
| Win32_SCSIControllerDevice | SCSI Controller Device |
| | Information |
| Win32_SerialPort | Serial Port Information |
| Win32_Service | Installed Win32 Service |
| | Information |
| Win32_Share | Share Information For File Share |
| | Migrations |
| Win32_SoftwareFeature | Software Component |
| | Information |
| Win32_SoundDevice | Sound Card Information |
| Win32_StartupCommand | List Of Startup Commands |
| Win32_SystemDriver | System Driver Information |
| Win32_SystemEnclosure | System Enclosure Information |
| Win32_SystemTimeZone | Current System Time Zone |
| | Information |
| Win32_TapeDrive | Tape Drive Information |
| Win32_TimeZone | Time Zone Information |
| Win32_UserInDomain | Identifies If The User Is In |
| | The Domain |
| Win32_VideoConfiguration | Video Configuration Information |
| Win32_VideoController | Video Controller Settings |
| Win32_WindowsProductActivation | Windows Product Activation |
| | Information |

Additionally, an inventory collector 210 can be associated with Active Directory®. In this example, LDAP queries can be executed against Active Directory®, if present. Queries against the Active Directory User object can be employed to retrieve information such as the user's name, address, phone number, location and manager. In addition, the computer object can be employed to identify servers, workstations, domain controllers and/or global catalogs etc.

In this example, the inventory collector 210 can return information from the User and Computer class using System.DirectoryServices Namespace. If Active Directory® has been deployed, machines that are not currently attached to the network can be identified. For example, this can be very useful for identifying laptops in use by traveling salesmen and/or machines that have been turned off for some reason.

User information can be obtained by reading attribute(s) from the User object, for example:

TABLE 3

| User Information | Active Directory Attribute |
|---|---|
| Address | streetAddress |
| Alias Name | mailNickname |
| Assistant | telephoneAssistant |
| Assistant's Name | Secretary |
| City Name | L |
| Company Name | Company |
| Country/Region | Co |
| Department Name | Department |
| Direct Reports Info | directReports |
| E-mail Address | legacyExchangeDN |
| E-mail Addresses | proxyAddresses |
| First Name | givenName |
| Full Name | displayName |
| Initials | Initials |
| Last Name | Sn |
| Manager's Name | Manager |
| Office Address | physicalDeliveryOfficeName |
| Phone | telephoneNumber |
| Post Office Box | postOfficeBox |
| Sam Account Name | sAMAccountname |
| State | St |
| Title | Title |
| User Logon Name | userPrincipalName |
| Zip code | postalCode |

Those skilled in the art will recognize that additional information can be collected from Active Directory for users.

Computer information can be collected from the Active Directory Computer object, for example:

TABLE 4

| Computer Information | Active Directory Attribute |
|---|---|
| Account-Expires | accountExpires |
| Assistant | Assistant |
| Code-Page | codePage |
| Common-Name | Cn |
| Create-Time-Stamp | createTimeStamp |
| Description | Description |
| Display-Name | displayName |
| DNS-Host-Name | dNSHostName |
| Given-Name | givenName |
| Last-Logon | lastLogon |
| Locale-ID | localeID |
| Location | Location |
| Machine-Role | machineRole |
| Manager | Manager |
| Netboot-GUID | netbootGUID |
| Network-Address | networkAddress |
| Object-Guid | objectGUID |
| Operating-System | operatingSystem |
| Operating-System-Hotfix | operatingSystemHotfix |
| Operating-System-Service-Pack | operatingSystemServicePack |
| Operating-System-Version | operatingSystemVersion |
| Physical-Location-Object | physicalLocationObject |
| User-Principal-Name | userPrincipalName |

Those skilled in the art will recognize that additional information can be collected from Active Directory for computers.

Next, SNMP can be employed by a particular inventory collector 210 to identify Internet protocol (IP) addressable network devices such as routers, switches, and/or fire walls etc. using standard SNMP Management Information Bases (MIBs). SNMP can be further employed to identify computer(s) and/or server(s) running operating system(s) not recognized by other inventory collector(s) 210.

While several particular mechanisms facilitating the discovery of computer hardware component(s) and/or software component(s) have been discussed herein, it is to be appreciated that any type of mechanism suitable for carrying out the claimed subject can be employed and all such types of mechanisms are intended to fall within the scope of the hereto appended claims.

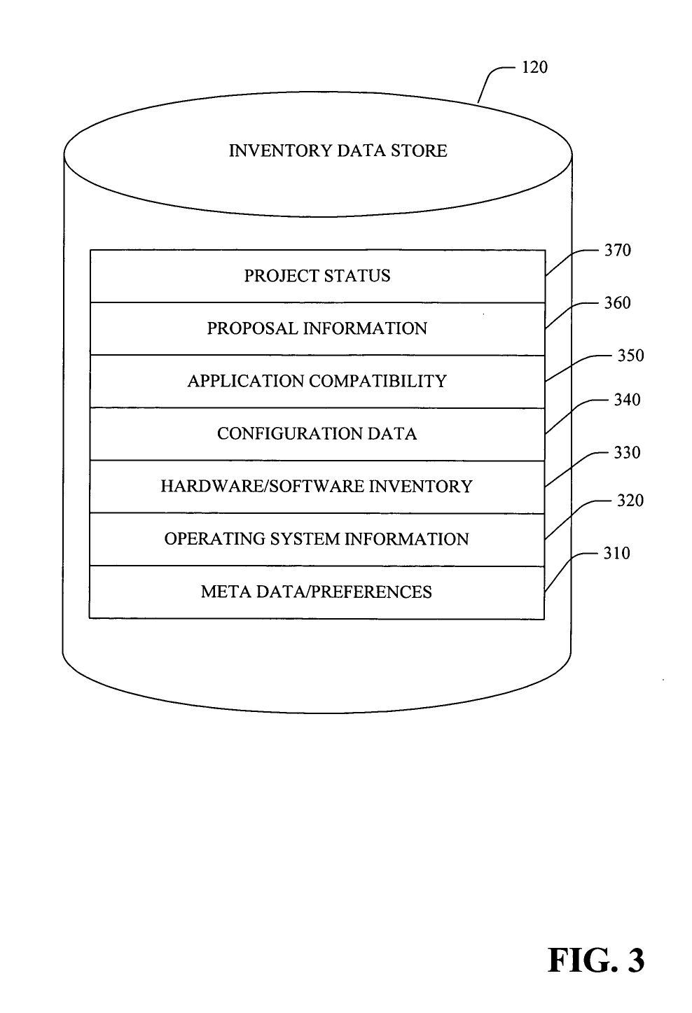

Next, referring to FIG. 3, an exemplary data store 120 is illustrated. The data store 120 (e.g., database) can be stored, for example, on a server, on an IT professional's laptop and/or a computer on the customer's network. If used by an IT consultant with access to proprietary information for various customers, information about each customer can be stored in a separate database (e.g., information which proprietary/confidential is maintained as such).

In this example, the data store 120 stores includes meta data 310 that describes upgrade rules, operating system information 310 such as version and registered user, a hardware/software inventory 330, configuration information 340 and/or application compatibility data 350. The data store 120 further includes proposal information 360 which can be generated based on the collected inventory, as discussed below. Further, the data store 120 can include project status 370 which is automatically updated as work is performed.

In one example, the hardware/software inventory 330 includes database tables that include information regarding hardware/software inventory, for example:

| Table Name | Table Type | Description |
|---|---|---|
| CDROMDrives | Detail | Describes CD ROM |
| | | and/or DVD drive(s) on |
| | | a computer. Contains |
| | | one row per device. |
| Devices | Master | Stores information about |
| | | workstations, servers, |
| | | hand hands, network |
| | | devices etc. Contains |
| | | one row per device. |
| DiskDrives | Detail | Describes disk drive(s), |
| | | if any on a computer. |
| | | Contains one row per |
| | | device. |
| DiskPartitions | Detail | Describes disk partitions |
| | | on a computer. Contains |
| | | one row per paritition. |
| InfraredDevices | Detail | Describes infrared |
| | | devices, if any, on a |
| | | computer. Contains one |
| | | row per device. |
| Keyboards | Detail | Describes keyboard(s) |
| | | on a computer. Contains |
| | | one row per device. |
| LocalAccounts | Detail | Stores a list of local |
| | | account(s) created on a |
| | | computer. Contains one |
| | | row per local account. |
| LogicalDisks | Detail | Describes logical disk |
| | | drive(s), if any, on a |
| | | computer. Contains one |
| | | row per device. |
| MemoryConfigurations | Detail | Described memory |
| | | chip(s) installed on the |
| | | motherboard. |
| Modems | Detail | Describes modem(s), if |
| | | any, attached to a |
| | | computer. Contains one |
| | | row per modem. |
| Monitors | Detail | Describes monitor(s) |
| | | attached to a computer. |
| | | Contains one row per |
| | | monitor. |
| MotherboardDevices | Detail | Describes information |
| | | about the computer |
| | | motherboard. |
| NetworkAdapterConfigurations | Detail | Describes the |
| | | configuration of each |
| | | network adapter |
| NetworkAdapters | Detail | Describes each network |
| | | adapter installed on the |
| | | device. Contains one |
| | | row per adapter. |
| ParallelPorts | Detail | Describes each parallel |
| | | port installed on the |
| | | device. Contains one |
| | | row per port. |
| Patches | Detail | Describes each software |
| | | patch that has been |
| | | installed on the |
| | | computer. Contains one |
| | | row per patch. |
| PointingDevices | Detail | Describes each pointing |
| | | device, if any, installed |
| | | on a computer. Contains |
| | | one row per device. |
| Printers | Detail | Describes each software |
| | | printer, if any, that has |
| | | been installed locally on |
| | | a computer. Contains |
| | | one row per printer. |
| Products | Detail | Describes product(s) that |
| | | have been installed via |
| | | Add/Remove Programs. |
| | | Contains one row per |
| | | product. |
| Patches | Detail | Describes software |
| | | patch(es) that have been |
| | | installed on a computer. |
| | | Contains one row per |
| | | patch |
| SCSIControllers | Detail | Describes each SCSI |
| | | Controller installed on a |
| | | computer. Contains one |
| | | row per SCSI Controller. |
| SerialPorts | Detail | Describes serial port(s) |
| | | that have been installed |
| | | on a computer. Contains |
| | | one row per serial port |
| Services | Detail | Describes each Win32 ® |
| | | Service that has been |
| | | installed on a computer. |
| | | Contains one row per |
| | | Win32 ® service. |
| Shares | Detail | Describes each file share |
| | | that has been created on |
| | | a computer. Contains |
| | | one row per file share. |
| SoftwareFeatures | Detail | Describes component(s) |
| | | that have been installed |
| | | on a computer with a |
| | | product. Contains one |
| | | row per |
| | | feature/component. |
| SoundDevices | Detail | Describes sound card(s), |
| | | if any, that have been |
| | | installed on a computer. |
| | | Contains one row per |
| | | sound device. |
| StartupCommands | Details | Describes startup |
| | | command(s) that have |
| | | been configured on a |
| | | computer. Contains one |
| | | row per startup |
| | | command. |
| SystemDrivers | Detail | Describes driver(s) that |
| | | have been installed on a |
| | | computer. Contains one |
| | | row per device driver. |
| TapeDrives | Detail | Describes tape drive(s), |
| | | if any, installed on a |
| | | computer. Contains one |
| | | row per tape drive. |
| TimeZones | Detail | Describes each time |
| | | zone that has been |
| | | configured on a |
| | | computer. |
| USBControllers | Detail | Describes USB |
| | | controller(s), if any, that |
| | | have been installed on a |
| | | computer. Contains one |
| | | row per USB controller. |
| VideoControllers | Detail | Describes video card(s) |
| | | that have been installed |
| | | on a computer. Contains |
| | | one row per video card. |
| Users | Master | Describes each user |
| | | account created in |
| | | Active Directory ®. |
| | | Contains one row per |
| | | user. |

With regard to automation, the inventory data store 120 can include, for example, database tables including:

| Table Name | Table Type | Description |
|---|---|---|
| StepConstraints | Detail | Contains the constraints |
| | | for a specific step. |
| | | Constraints include a set of |
| | | “OR” and “AND” |
| | | conditions. There is one |
| | | row per constraint. |
| Steps | Detail | Describes the steps in the |
| | | task sequence. Steps |
| | | control the flow of |
| | | execution based on one or |
| | | more optional constrains. |
| | | Includes one row per step. |
| TaskParameters | Detail | Describes the parameter(s) |
| | | for each task. Parameters |
| | | allow sate to be shared |
| | | across tasks |
| Tasks | Detail | Describes each task in a |
| | | task sequence. A task |
| | | defines what process is to |
| | | be executed. There is one |
| | | row per task. |
| TaskTypes | Detail | Tasks can be of different |
| | | types. There is one row |
| | | per Task Type. For |
| | | example, CREATE |
| | | PROCESS, EXEC |
| | | QUERY, etc. |
| WorkFlowExecutions | Detail | Stores the execution |
| | | history of each workflow. |
| | | One row per execution of a |
| | | workflow. |

Referring back to FIG. 1, optionally, the system 100 can include an inventory wizard 130(e.g., user interface). The inventory wizard 130can be employed to specify the information a user, for example, an IT professional, desires the system 100 to collect. For example, an IT professional can plug his/her laptop into a customer's network and employ the inventory wizard 130to quickly specify the information the IT professional desires to collect. In one example, the IT professional chooses a default that uses LAN Manager, Active Directory, WMI and SNMP to collect hardware and software information. This gives the IT professional a detailed understanding of the assets installed in this environment.

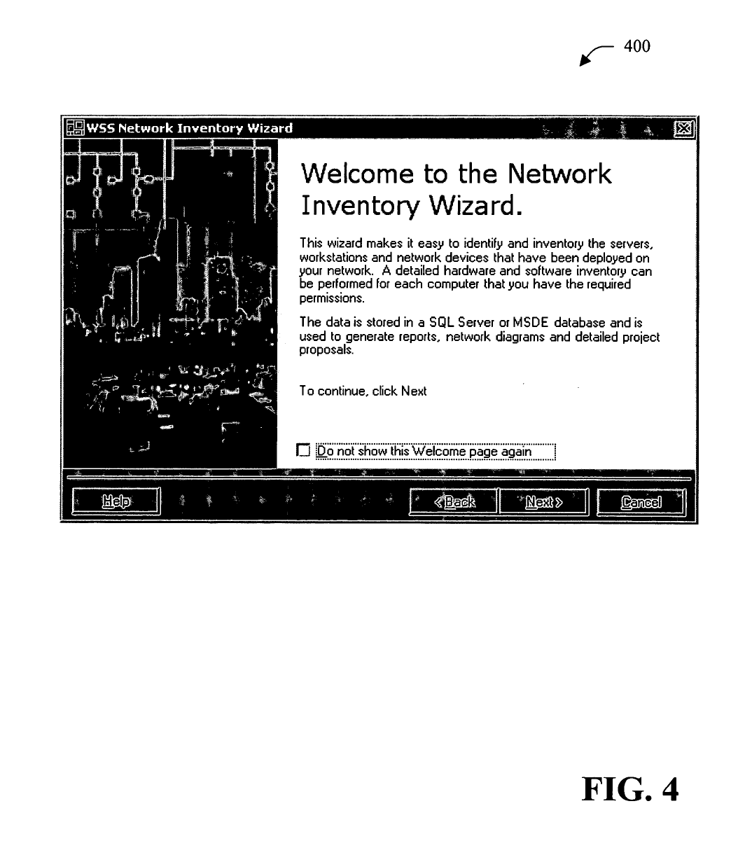

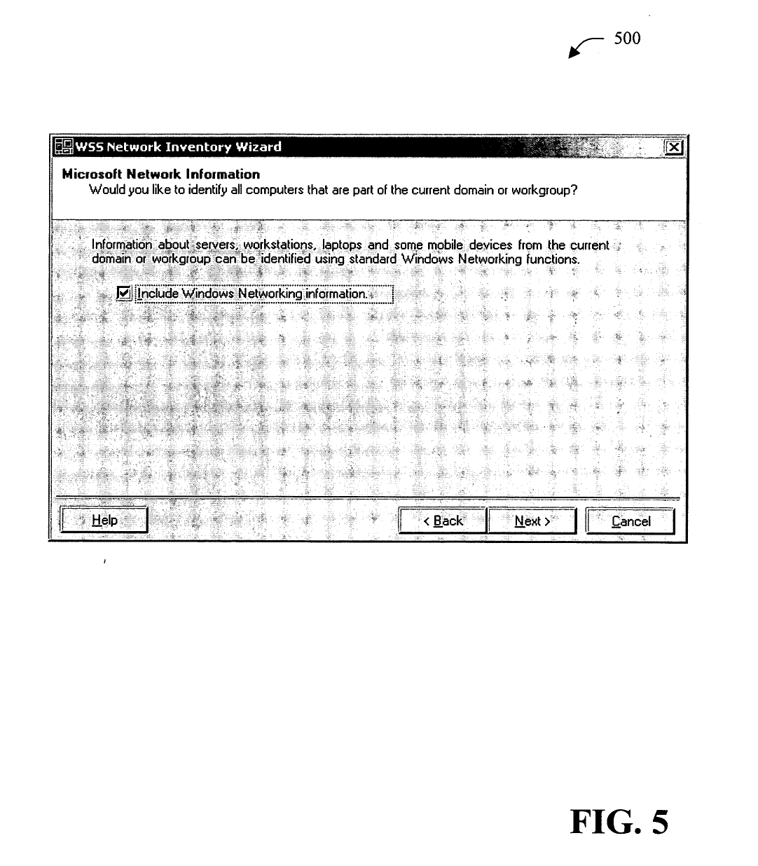

Referring briefly to FIGS. 4-10, screen shots of an exemplary inventory wizard session are illustrated. FIG. 4 is a screen shot of a user interface 400 of initiation of the inventory wizard 130. Next, FIG. 5 is a screen shot of a user interface 500 regarding networking information to be included in the inventory generated by the system 100. For example, if selected, NetServerEnum( ) can be invoked to get machine and operating system information.

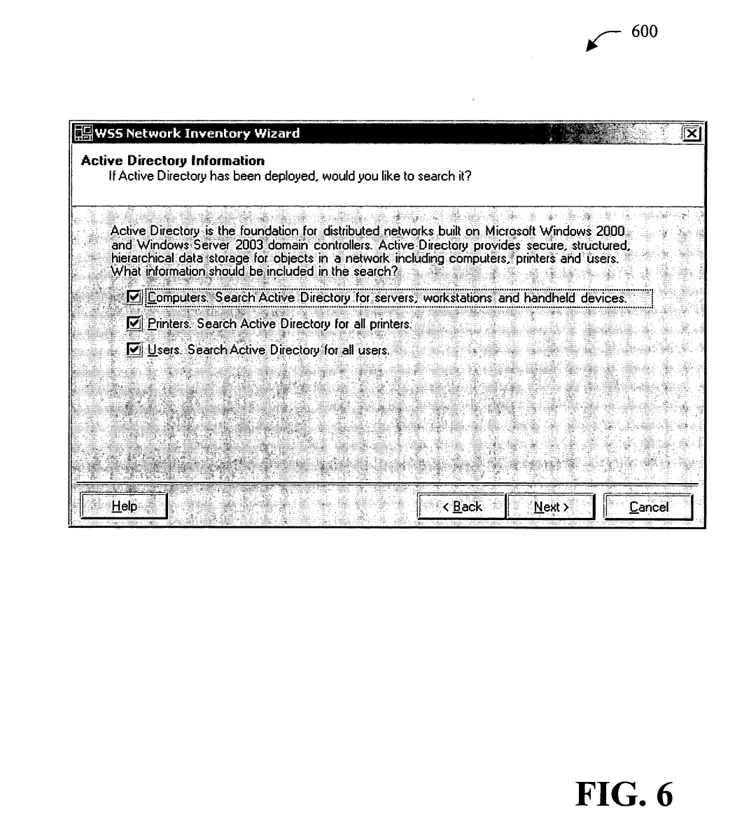

FIG. 6 is a screen shot of a user interface 600 that facilitates identification/selection of components of Active Directory® information. A user can selectively include computers, printers and/or user in the inventory generated by the system 100.

If this machine is part of an Active Directory forest, this page is displayed as is. If not, an additional page is provided that prompts the user for the DNS name of the forest and allow the user to specify their user name and password. This is required because the IT professional's laptop will probably not be part of the customer's forest. In this example, the user is queried for users, computers and printers in case there are any privacy concerns.

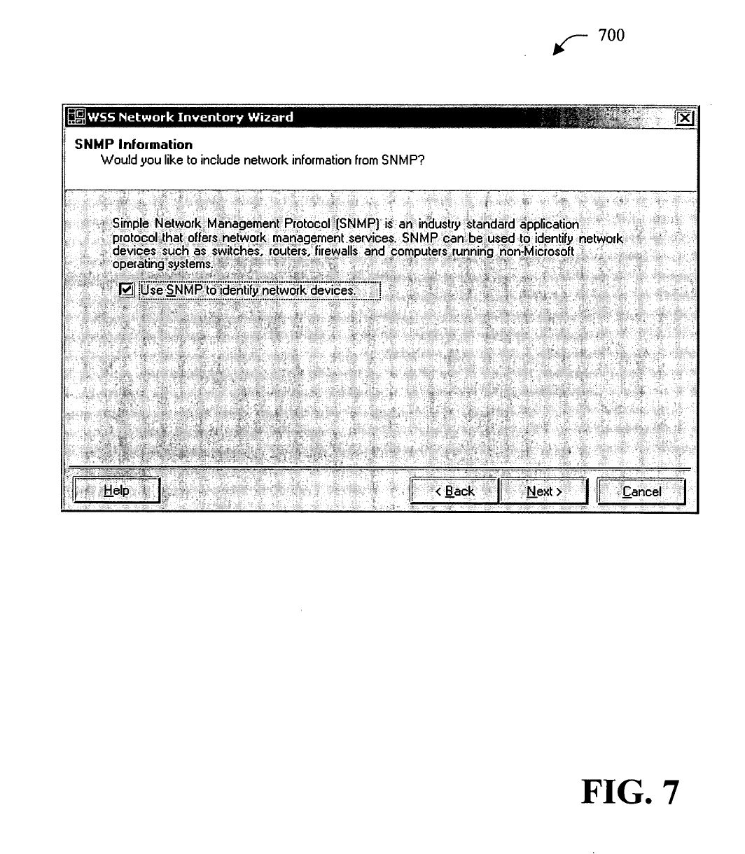

FIG. 7 is a screen shot of a user interface 700 regarding the use of SNMP information. In this example, a user can select whether or not the system 100 is to employ SNMP to identify network devices.

If selected, the system 100 can interrogate IP addressable devices for standard MIBs using SNMP. This allows the system 100 to identify firewalls and network attached printers. Optionally, the user can be allowed to specify SNMP READ community strings as a simple grid. Each community string can be used in the order specified to request device information.

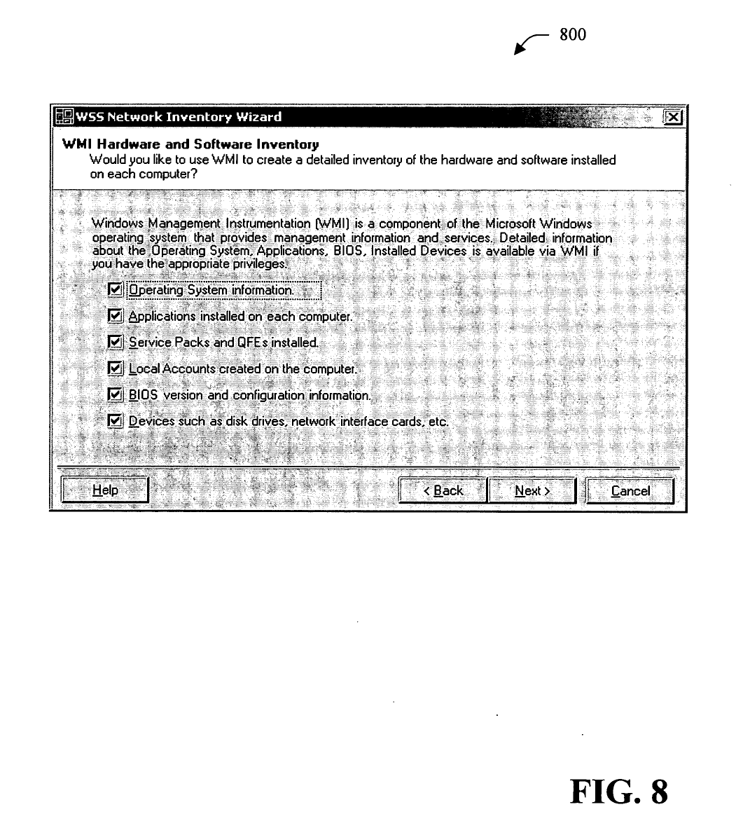

Next, FIG. 8 is a screen shot of a user interface 800 of WMI hardware and software inventory to be collected by the system 100. A user can selectively include operating system information, applications installed on each computer, service packs and software patch(es) installed, local accounts created on the computer, BIOS version and configuration information, and/or, devices such as disk drives, network interface cards, etc.

WMI can be used to collect hardware/software inventory. Since administrator privileges are required to enumerate WMI inventory, a grid can be provided that allows the entry of account names and passwords (e.g., which are not persisted). For each machine, the credentials are used in order until they can connect to the machine or run out of accounts.

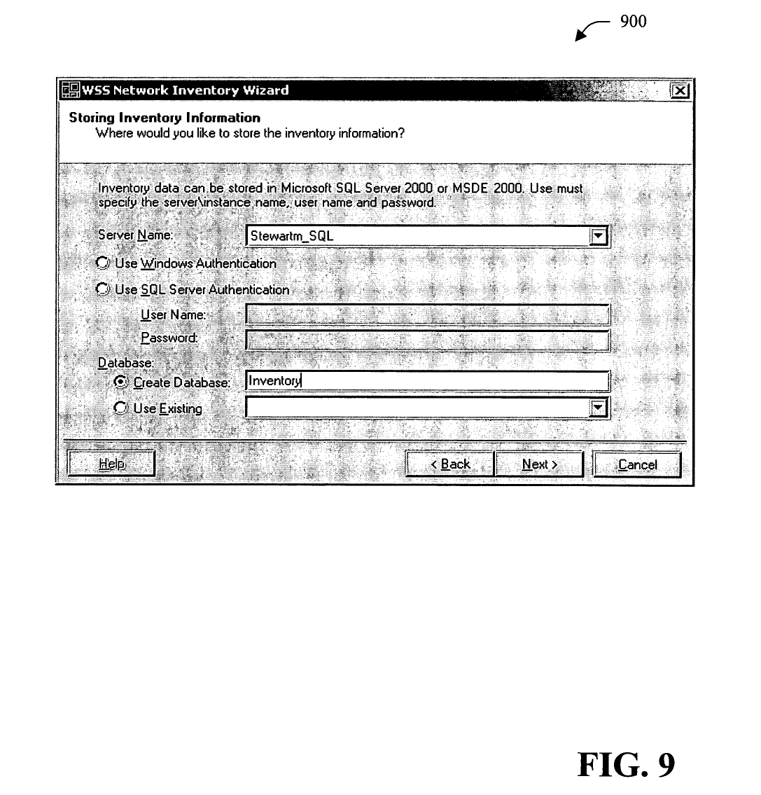

With the user interface 900 illustrated in FIG. 9, a user (e.g., IT professional) can provide information for use by the system 100 for storing the inventory data store 120. For example, a user can identify a server name to store the inventory data store 120 along with authentication information. Further, the user can identify a name for the inventory data store 120 or, if one already exists, which existing inventory data store 120 to employ.

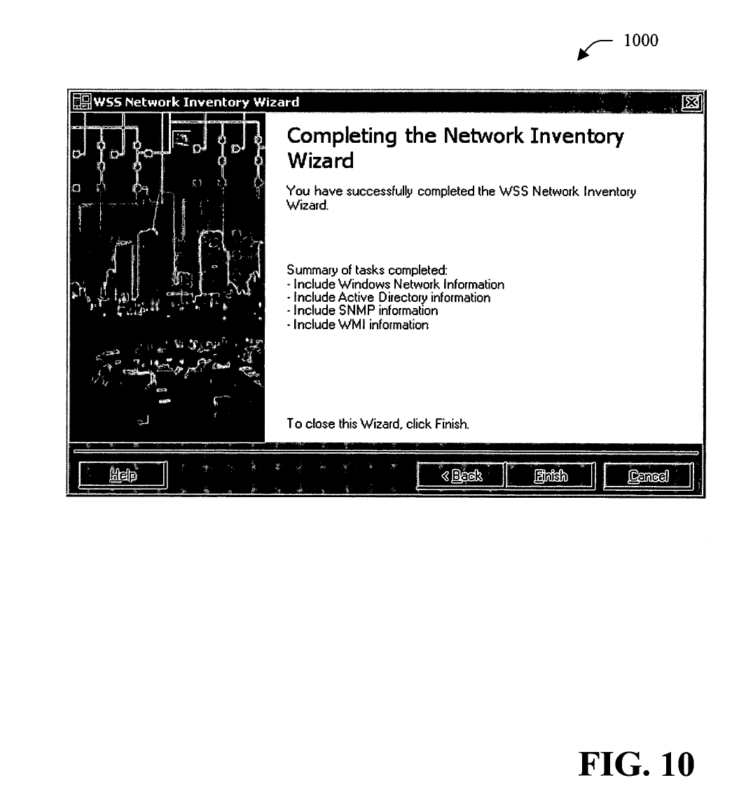

Finally, FIG. 10 is a screen shot of a user interface 1000 of completion of the inventory wizard 130. In this example, a summary of the task completed is provided to the user via the screen shot 1000.

Automated Network Deployment

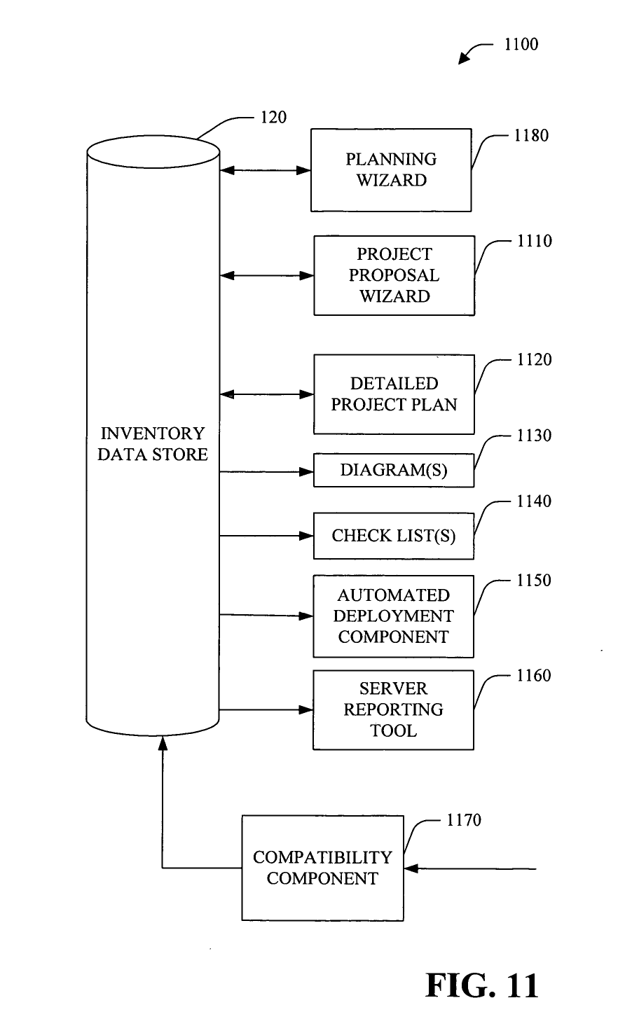

Referring to FIG. 11, an automated network deployment system 1100 is illustrated. The system 1100 includes an inventory data store 120, for example, collected by the automated network assessment system 100. The system 1100 can further include a project proposal wizard 1110 (e.g., user interface), a detailed project plan 1120, diagram(s) 1130, checklist(s) 1140, an automated deployment component 1150, a server reporting tool 1160 and/or a compatibility component 1170.

The project proposal wizard 1110 (e.g., user interface) can be employed to facilitate generation of a detailed draft proposal that the IT professional can present to a customer for consideration. For example, the draft proposal can include information regarding upgrades of server(s) and/or particular workstations.

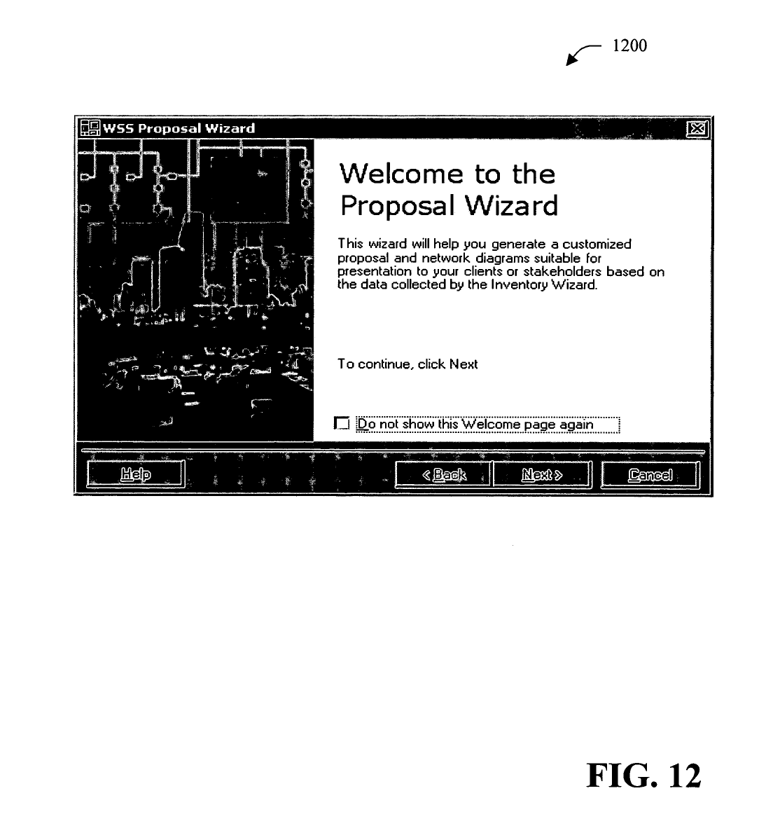

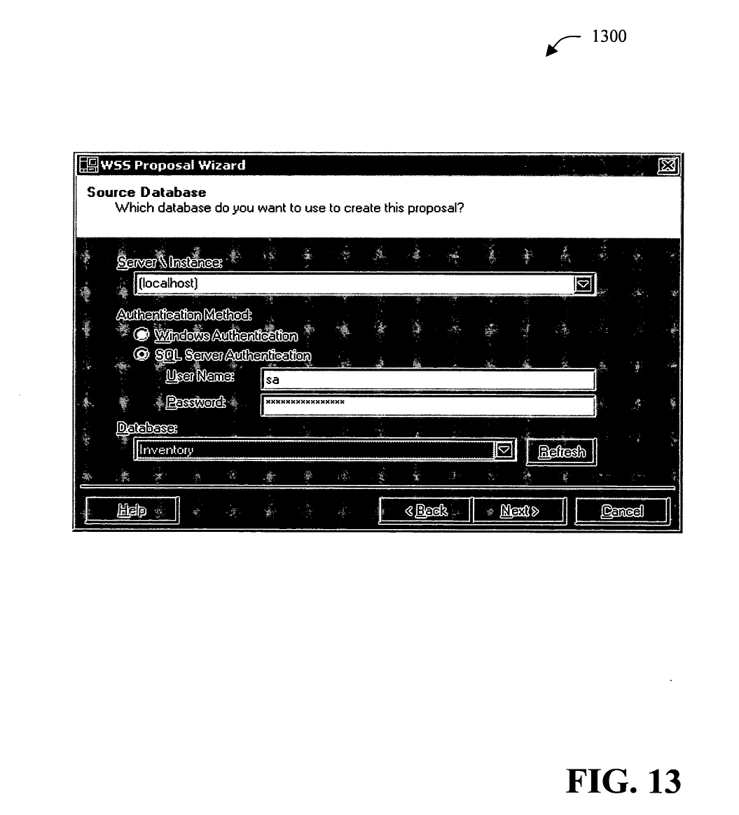

Turning to FIGS. 12-21, screen shots of an exemplary project proposal wizard session are illustrated. FIG. 12 is a screen shot of a user interface 1200 of a welcome screen. FIG. 13 is a screen shot of a user interface 1300 facilitating identification of information to be employed in generating the proposal. For example, a user can identify a server, an authentication method, and, a particular inventory data source 120 to be used.

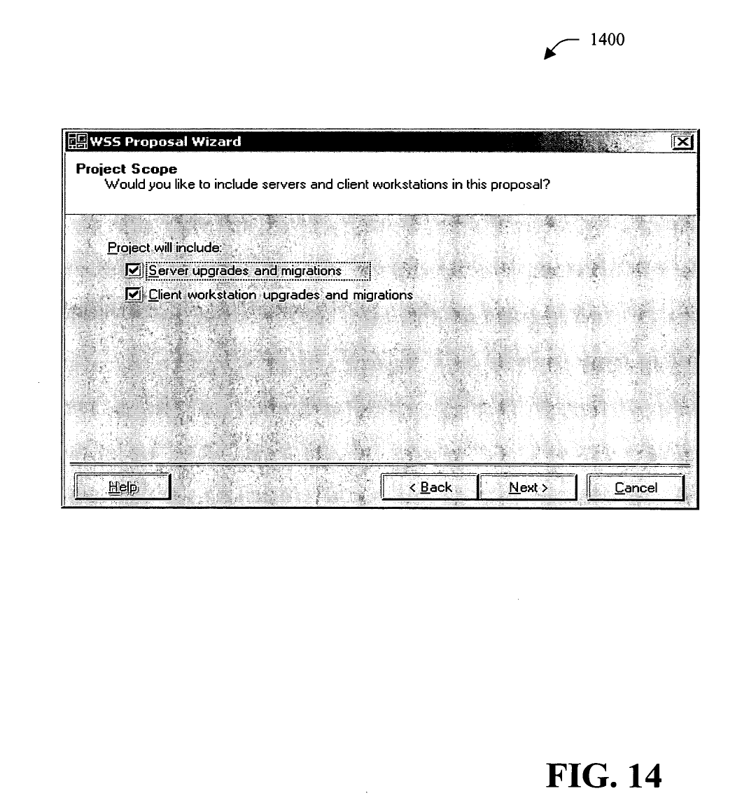

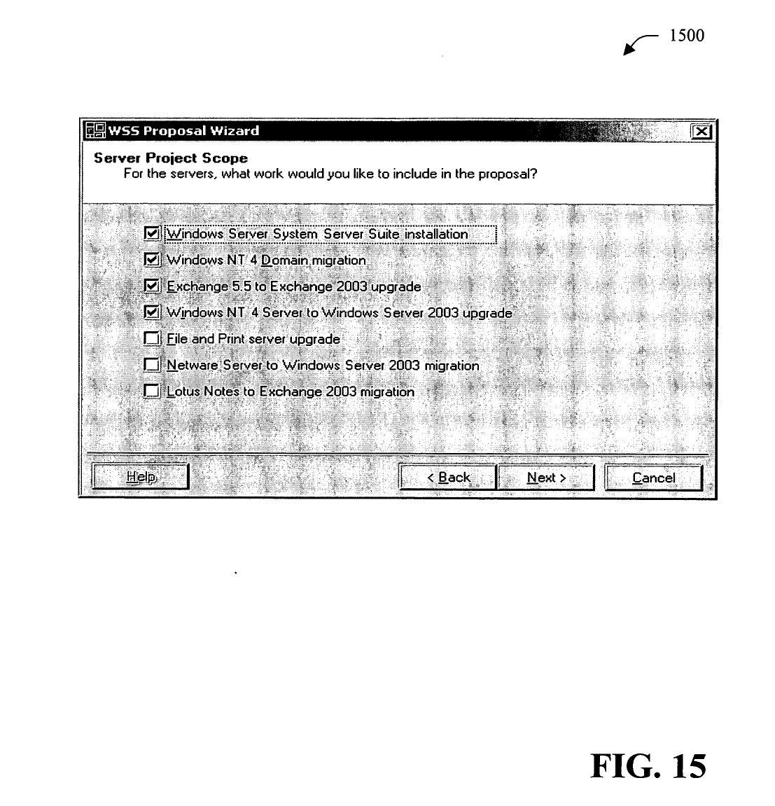

Next, referring to FIG. 14, a screen shot of a user interface 1400 regarding the project scope to be employed in generation of the proposal is illustrated. FIG. 15 is a screen shot of a user interface 1500 that facilitates identification of servers to be included in the proposal.

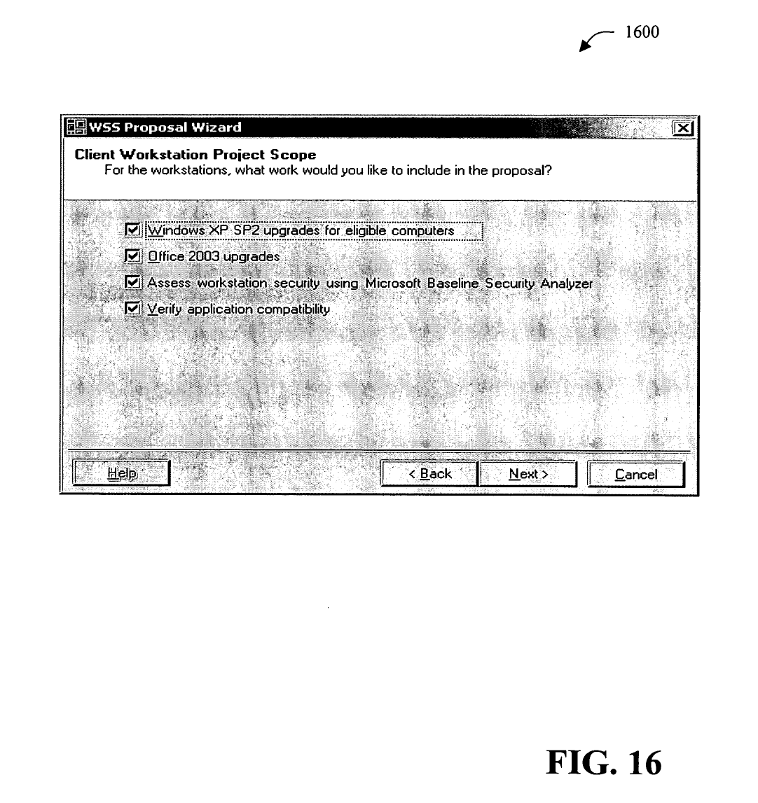

FIG. 16 is a screen shot of a user interface 1600 employed to identify client workstation project scope. With this user interface, a user can identify whether or not to include upgrade(s), to access workstation security and/or to verify application compatibility.

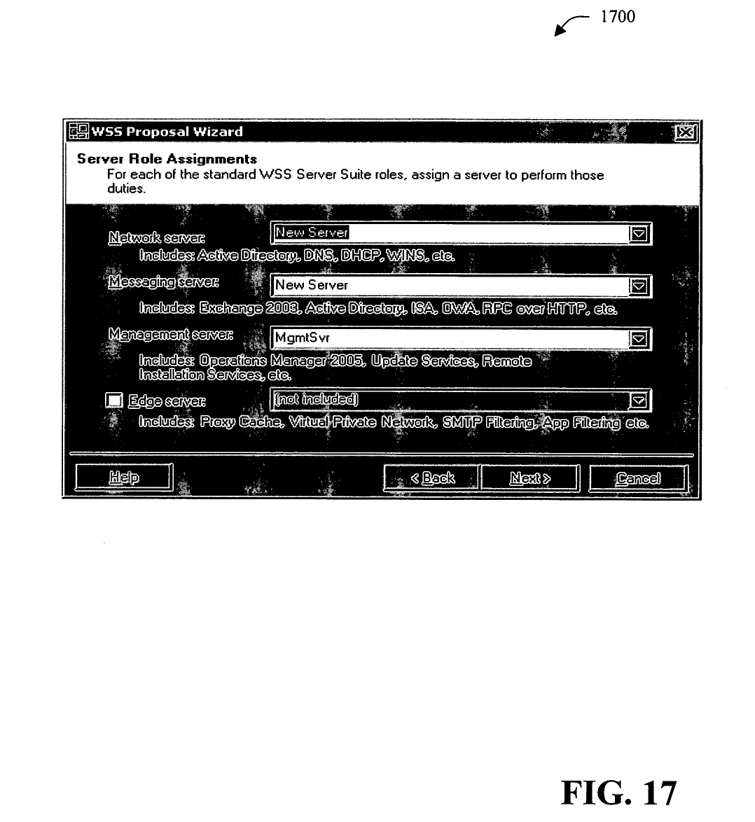

Next, FIG. 17 is a screen shot of a user interface 1700 facilitating identification of server role assignments. For example, a user can identify a network server, a messaging server, a management server and, optionally, an edge server.

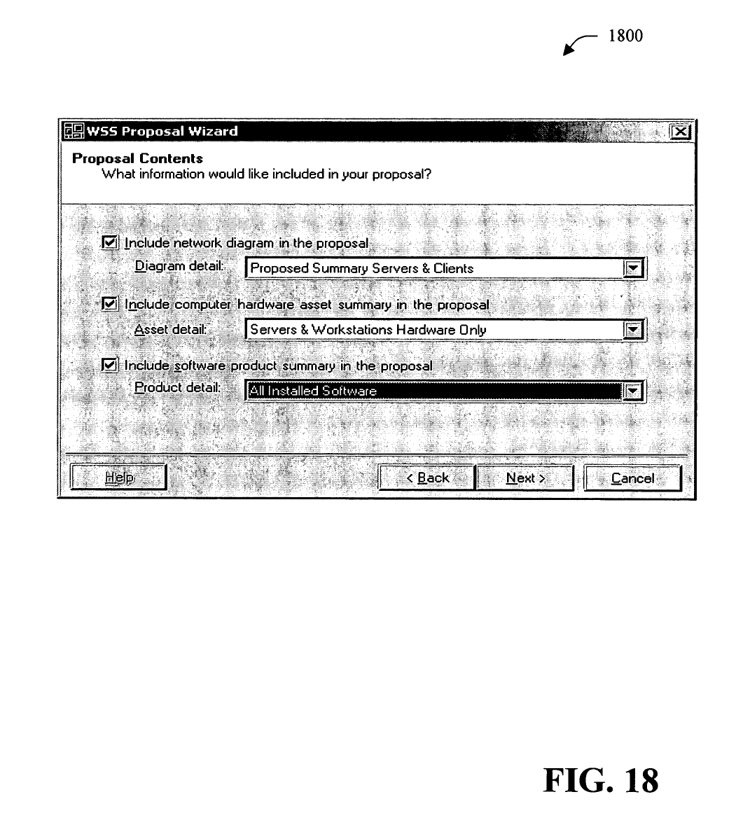

FIG. 18 is a screen shot of a user interface 1800 facilitating identification of information to be included in the proposal. For example, network diagram(s), a computer hardware asset summary and/or software product summary can be selectively included in the proposal.

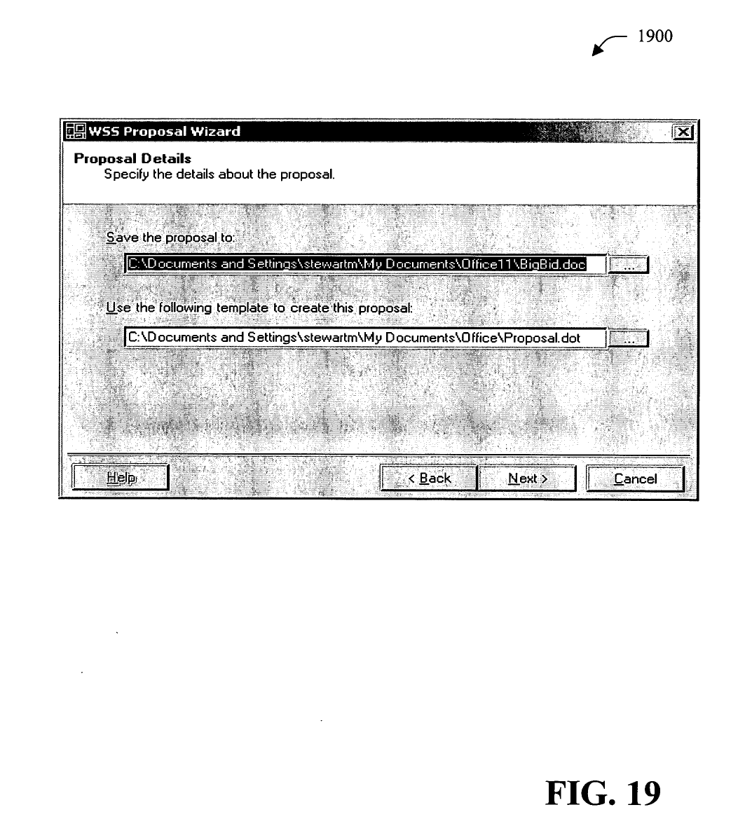

Referring next to FIG. 19, a screen shot of a user interface 1900 facilitating identification of details for the proposal to be generated is provided. For example, a user can identify a location (e.g., file name) for the saved proposal and/or a template to be employed when generating the proposal. For example, a template can allow the IT professional to customize with the IT professional's logo, address, phone number and/or control the document's formatting and section ordering etc.

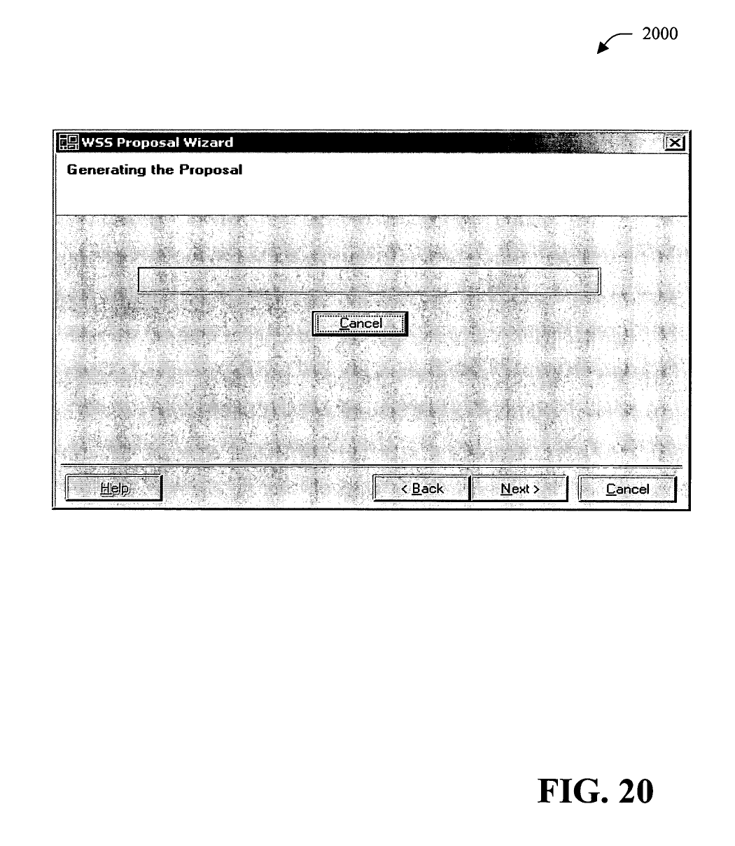

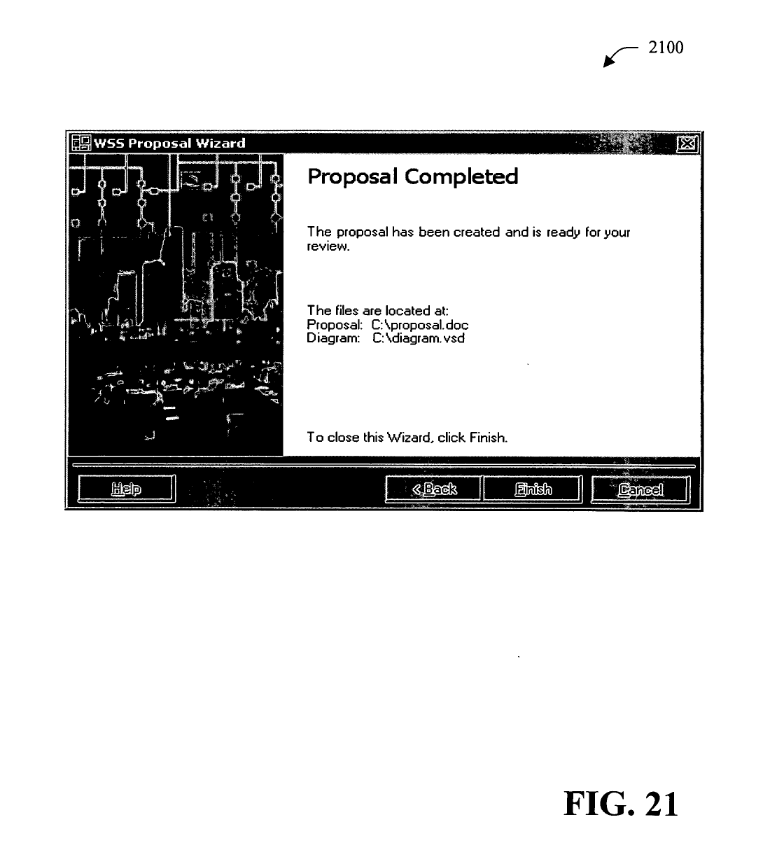

FIG. 20 is a screen shot of a user interface 2000 presented while the proposal is being generated by the system 1100. Finally, FIG. 21 is a screen shot of a user interface 2100 employed for proposal completion. The user interface 2100 can identify storage location(s) of the proposal and/or associated diagram(s). An exemplary proposal is included in Appendix A and is part of this specification.

The project proposal summarizes the work (e.g., to be covered in a bid). Proposals can include, for example:
1. Migration from one server operating system to another;
2. Upgrading of software application(s);
3. Installation and configuration of VPN/Connected User Scenarios;
4. Installation and configuration of health monitoring software;
5. Installation and configuration of update services (client patching); and/or
6. Active Directory® Group Policy (Configuration and Software Distribution)

Returning to FIG. 11, the detailed project plan 1120 can be generated by the system 1100 and can further reduce the time on-site required by the IT professional. The detailed project plan 1120 can proactively identify known compatibility problem(s), if any, and recommended remediation before upgrade/migration commences.

For example, the project plan 1120 can include a list of the software to be installed and all of the configurations selected. The scope of the project plan 1120 can be based on the project proposal wizard 1110, as discussed above.

Next, detailed inventory and proposal information in the inventory data store 120 can be employed to automatically generate diagram(s) 1130 that summarize the current and/or proposed architecture. These diagram(s) 1130 can make it easy for both the IT professional and the customer to understand exactly what has been deployed in production.

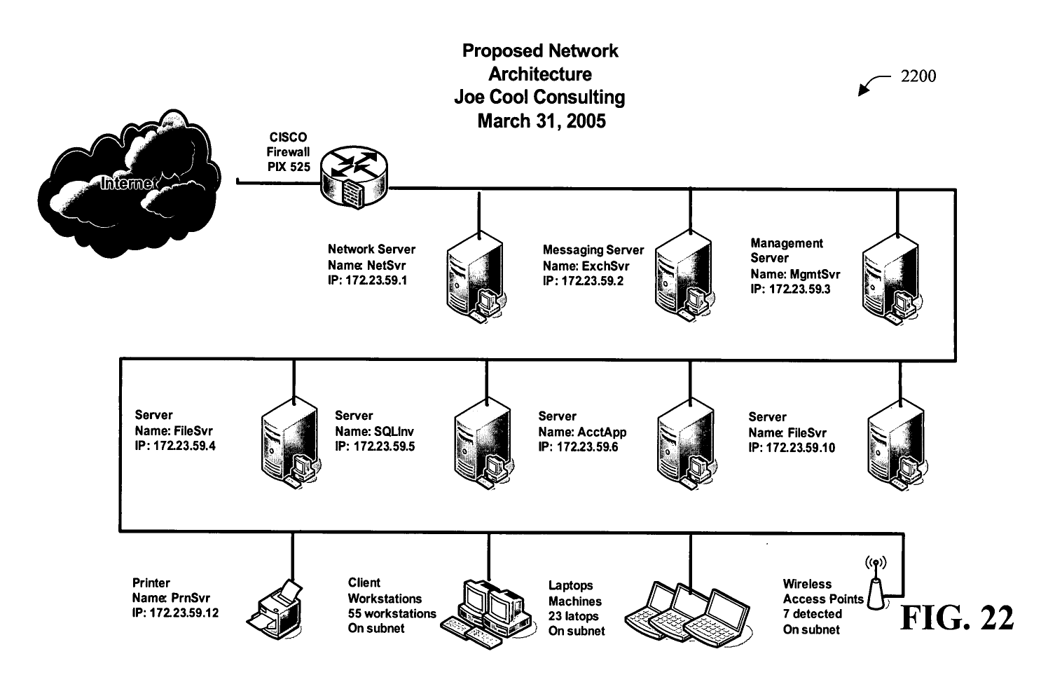

Referring briefly to FIG. 22, an exemplary diagram 2200 is illustrated. In this example, the diagram 2200 is comprised of a tree of subnets. Each subnet is identified and sorted by IP Address.

Each node on the diagram 2200 includes an icon that represents the machine type and a text box that summarizes its most important properties such as machine role, machine name and IP address. The icon and text box can be grouped together so they don't become separated if the diagram is manually laid out. The machine type can be defined by the WMI SystemEnclosure class ChassisTypes attributed stored in the inventory data store 120. For example, laptops can have ChasisTypes value of 10. Different icons can be used to represent Servers, Blades, Laptops, Notebooks, PDAs, Switches, Routers, Firewalls and wireless access points based on their ChasisTypes value. In this example, each printer and network file share is drawn on the diagram.

To reduce clutter on the diagram 2200, client workstations, laptops, PDAs are not included. However, in this example, a summary of the number for a given ChasisTypes can be added on the bottom line for each subnet. A special icon showing multiple machines/laptops/etc. can be used to indicate it is a summary rather than a specified node.

In one example, “as-is” diagrams can be generated by the system 1100 which depict only server(s) and summarizes laptops/desktops. Further, a proposed diagram can be generated which depicts proposed server(s), client(s) and/or network device(s) as upgraded/migrated. Additionally, a complete asset diagram can be generated that shows the server(s), client(s) and/or network device(s) that have been discovered.

Returning to FIG. 11, the proposal generated by the system 1100 can include detailed checklist(s) 1140 that can be used, for example, by less experienced consultants during deployment. The checklist(s) 1140 can provide details of an upgrade/migration plan that specifically describes the location of each service and steps required to complete the upgrade/migration. The checklists 1140 can include a list of the tasks with finish start relationships based on success which reduces the number of items.

The checklist(s) 1140 and other aids can be customized to the specific environment. For example, the actual computer names and IP addresses can be used in these documents, not just generic values. Furthermore, the sections of the document can change depending on the specific environment, so if a customer is doing a specific type of migration of a system, then the documents only describe the

In one example, the checklist(s) 1140 are driven from the WorkflowStepExecutions table (discussed above). Whenever a step/task is executed, the checklists 1140 are automatically updated. This makes it easy to get current accurate information of the project's status.

For example, an IT professional can include detailed checklist(s) 1140 as part of the IT professional's proposal. The checklist(s) 1140 provide a concise and orderly task list for each machine. Since it can be very easy to skip a step and have to redo an installation/migration, the checklist 1140 summarizes in order all of the tasks to be completed and details on which machines they are to be performed. This reduces the time to complete the installation and reduces the chance of time-consuming mistake(s).

Finally, the automated deployment component 1150 can automate deployment (e.g., installation and configuration) of the server operating system and various service components. The automation can include, for example, WINNT.SIF file generation for new Windows Server 2003 OS installation, scripts for configuration and verification of IT services, and prescriptive guidance for steps and sequencing of setup tasks. For example, the automated deployment component 1150 can generate unattended setup files, generate scripts for networks services setup, generate configuration scripts and/or silently install component(s). The automated deployment component 1150 can thus reduce the time to install and configure the network, messaging and management servers.

The automated deployment component 1150 can employ information from a user (e.g., IT consultant) via a planning wizard 1180. The planning wizard 1180 (e.g., user interface) can generate workflow for a specific environment based upon information obtained from the user (e.g., based on customer requirement(s)/preference(s).

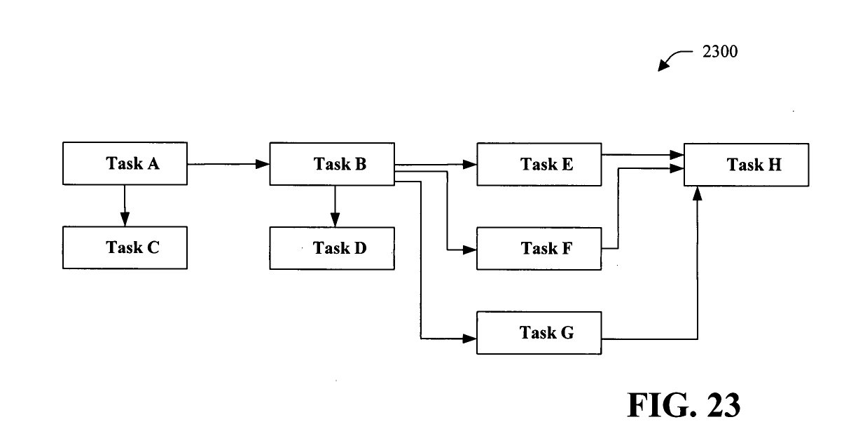

Turning to FIG. 23, a task flow diagram 2300 is illustrated. Server setup and migration require the ability to coordinate the execution of a complex sequence of tasks. In the diagram 2300, Task A is executed first. If it succeeds, Task B will be executed after it completes. If Task A fails, then Task C will be executed. If Task B is executed and succeeds, then Task E, Task F and Task G will be executed in parallel. If Task B fails, then Task D will be executed and the workflow terminates. If Task B succeeds, then Task H will only be executed if Task E, Task F and Task G succeed.

The sequence of FIG. 23 is an example of a directed acyclic graph. A directed graph does not contain any cycles and can be visualized as a tree of nodes to be executed. Directed graph can be easily modeled using the concepts of tasks, steps, precedence constraints and parameters.

As noted previously, with regard to automation, the inventory data store 120 can include database tables facilitating task sequencing. The database provides a centralized server to control the execution of tasks on multiple machines in the networked environment. In this example, a transaction-oriented workflow system that supports parallel execution can be supported.

In this example, the task sequence, or workflow, consists of an arbitrary number of steps. The steps control the flow of execution and identify what task should be executed. Each step is executed whenever all of its precedence constraints have been satisfied. This is an inherently parallel execution model. Any steps that have satisfied their precedence constraints will automatically be executed in parallel to reduce the total execution time.

Each step can optionally have one or more precedence constraints. A precedence constraint defines the state required for the step to execute. When a step is executed, it has an execution status of NotRun, Running, Success, Failure or Completed. NotRun means that the step has not been executed. Running indicates the step is currently executing and its execution status is unknown. Success indicates that the step completed execution successfully based on the Win32 process exit code. Failure indicates that the step failed for any reason and is indicated by a non-zero Win32 exit code.

Each precedence constraint defines the required execution status of its predecessor. For example, Task A has no precedence constraints and is therefore eligible for immediate execution. Task B has a precedence constraint that specifies Task A Success. Task C has a precedence constraint Task A Failure. Complex constraints can be created from a combination of Success, Failure and Completion statuses.

Steps control the flow of execution. Tasks describe what to execute. Each Task can be implemented, for example, as a Win32 Process, Batch File, SQL Server stored procedure or manual operation. The return code from the task defines the execution status for the step. Tasks can optionally define a compensation command that is implicitly executed on failure. In one example, the user provides the status code of manual operations.

A task often needs parameters that define a file path/name, server, user name or password. A task can have one or more parameters that are stored in the database. Parameters values can be shared between Tasks. This allows the output filename for Task A to be used as the input filename for Task B.

A workflow can be executed many times. Each execution of a workflow is stored in the WorkflowExecutions table. This summarizes the overall status of the workflow. Detailed information about the execution of each step/task is stored in the WorkflowStepExecutions table. Whenever a task completes execution, a stored procedure updates the state in the WorkFlowStepExecutions table. A trigger (e.g., SQL Server) on this table queries the WorkflowStepExecutions table to identify and execute any other steps that have all of their precedence constraints satisfied. If the workflow is completed, it writes the final status to the Workflow executions table.

Returning to FIG. 11, the inventory data store 120 schema can be documented so that IT professional(s) can create custom reports for their customers using server reporting tool(s) 450 (e.g., SQL Server Reporting Services). This can assist IT professional(s) troubleshoot future problems and/or provide analysis of existing assets to proactively manage more efficiently.

In one example, if an Internet connection is available, the system 1100 can check for updates using the compatibility component 1170. The compatibility component 1170 can identify known hardware and/or software compatibility issue(s), if any.

The system 1100 can further be employed to facilitate license summary (e.g., ensure that the customer has purchased the proper quantity of licenses for application and/or operating system software). Thus, the system 1100 can identify software licens(es) that are needed, the quantity of unused license(s) and/or projected future requirements.

Additionally, one or more views of the inventory data store 120 (e.g., database) can be provided. For example, a WorkflowConstraintStatus view can be provided that shows each workflow step and the status of its precedence constraints. A WorkflowExecutableSteps view can be provided that calculates which steps are eligible for execution. Further, a WorkflowCompletedSteps view can show which steps have been executed and calculates how long each step took to execute.

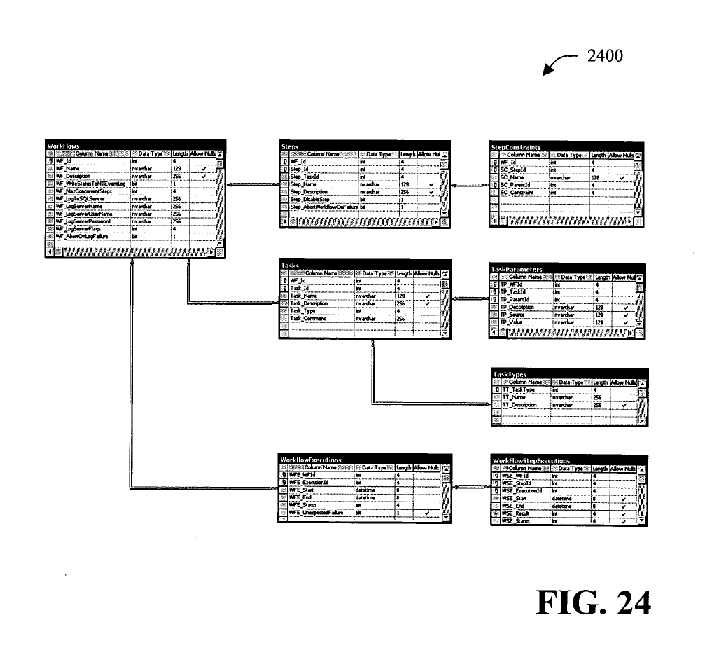

Next, stored procedures can be stored in the inventory data store 120. For example, an sp_ExecuteWorkflow stored procedure can execute a specified workflow. An sp_ExecuteStep stored procedure can execute each step in a workflow until no more steps are eligible for execution. Turning briefly to FIG. 24, an exemplary schema 2400 with respect to the workflow discussed above is illustrated. The ability to evaluate dependency(ies) of an acylclic graph using set-oriented SQL is powerful and can facilitate fault tolerance, restartability, etc.

Example Workflow Script

The following is an example workflow script:

```
DECLARE @err int
DECLARE @WFId int
/*
***********************************************************
  Define the System Task Types
***********************************************************
*/
EXEC @err = [sp_Add_TaskTypes]
    @Description = ‘Execute a Win32 Process’,
    @Name  = ‘WIN32’,
    @TaskType = 1
EXEC @err = [sp_Add_TaskTypes]
    @Description = ‘Execute a SQL Stored Procedure’,
    @Name  = ‘SQLProc’,
    @TaskType = 2
EXEC @err = [sp_Add_TaskTypes]
    @Description = ‘Execute a Workflow’,
    @Name  = ‘Workflow’,
    @TaskType = 3
/*
***********************************************************
  Create a new workflow
***********************************************************
*/
EXEC @err = [sp_Add_WorkFlows]
    @Name = ‘Test Workflow’,
    @Description = ‘Workflows Description’,
    @MaxConcurrentSteps = 100
SELECT  @err as ‘Error Code’
SELECT  @WFId = @@IDENTITY
SELECT @WFID as ‘WFID Value’
/*
***********************************************************
  Add Step A - No constraints
***********************************************************
*/
EXEC  @err = [sp_Add_Steps]
    @AbortWorkflowOnFailure = 1,
    @Description = ‘A Step Description’,
    @DisableStep = 0,
    @Step_Id = 1,
    @Name = ‘A Step’,
    @TaskId = 1,
    @WF_Id = @WFId
SELECT  @err as ‘Error Code’
/*
***********************************************************
  Add Step B - One Constraint on A = Success
***********************************************************
*/
EXEC  @err = [sp_Add_Steps]
    @AbortWorkflowOnFailure = 1,
    @Description = ‘B Step Description’,
    @DisableStep = 0,
    @Step_Id = 2,
    @Name = ‘B Step’,
    @TaskId = 2,
    @WF_Id = @WFId
SELECT  @err as ‘Error Code’
EXEC  @err = [sp_Add_StepConstraints]
    @Constraint = 1,
    @Name = ‘B Default Constraint Name’,
    @ParentId = 1,
    @StepId = 2,
    @ConstraintResult = 0,
    @ConstraintType = ‘OR’,
    @WF_Id = @WFId
SELECT  @err as ‘Error Code’
/*
***********************************************************
  Add Step C - One Constraint on A = FAILURE
***********************************************************
*/
EXEC  @err = [sp_Add_Steps]
    @AbortWorkflowOnFailure = 1,
    @Description = ‘C Step Description’,
    @DisableStep = 0,
    @Step_Id = 3,
    @Name = ‘C Step’,
    @TaskId = 1,
    @WF_Id = @WFId
SELECT  @err as ‘Error Code’
EXEC  @err = [sp_Add_StepConstraints]
    @Constraint = 1,
    @Name = ‘C Default Constraint Name’,
    @ParentId = 1,
    @StepId = 3,
    @ConstraintResult = 1,
    @ConstraintType = ‘OR’,
    @WF_Id = @WFId
SELECT  @err as ‘Error Code’
/*
***********************************************************
  Add Step D - One Constraint on B = SUCCESS or C = SUCCESS
***********************************************************
*/
EXEC  @err = [sp_Add_Steps]
    @AbortWorkflowOnFailure = 1,
    @Description = ‘D Step Description’,
    @DisableStep = 0,
    @Step_Id = 4,
    @Name = ‘D Step’,
    @TaskId = 3,
    @WF_Id = @WFId
SELECT  @err as ‘Error Code’
EXEC  @err = [sp_Add_StepConstraints]
    @Constraint = 1,
    @Name = ‘D Default Constraint Name’,
    @ParentId = 2,
    @StepId = 4,
    @ConstraintResult = 0,
    @ConstraintType = ‘OR’,
    @WF_Id = @WFId
SELECT  @err as ‘Error Code’
EXEC  @err = [sp_Add_StepConstraints]
    @Constraint = 1,
    @Name = ‘D Default Constraint Name’,
    @ParentId = 3,
    @StepId = 4,
    @ConstraintResult = 0,
    @ConstraintType = ‘OR’,
    @WF_Id = @WFId
SELECT  @err as ‘Error Code’
/*
***********************************************************
  Define the Tasks
***********************************************************
*/
EXEC @err = [sp_Add_Tasks]
    @Command = ‘sp_who’,
    @Description = ‘Find active SQL Server users’,
    @Id = 1,
    @Name = ‘Execute sp_who( )’,
    @Type = 2,
    @WF_Id = @WFId
EXEC @err = [sp_Add_Tasks]
    @Command = ‘sp_configure’,
    @Description = ‘Show or Configure SQL Server’,
    @Id = 2,
    @Name = ‘Execute sp_configure( )’,
    @Type = 2,
    @WF_Id = @WFId
EXEC @err = [sp_Add_Tasks]
    @Command = ‘sp_helpdb’,
    @Description = ‘Get information on each database’,
    @Id = 3,
    @Name = ‘Execute sp_helpdb( )’,
    @Type = 2,
    @WF_Id = @WFId
EXEC @err = [sp_Add_Tasks]
    @Command = ‘sp_failxxx’,
    @Description = ‘this sp will fail’,
    @Id = 4,
    @Name = ‘Execute a SP that will fail’,
    @Type = 2,
    @WF_Id = @WFId
```

To execute the workflow script:

DECLARE @err int
EXEC @err = sp_ExecuteWorkflow @WF_Id = 1, @WF_Name =
‘Test Workflow’
SELECT @Err AS ‘FinalStatus’

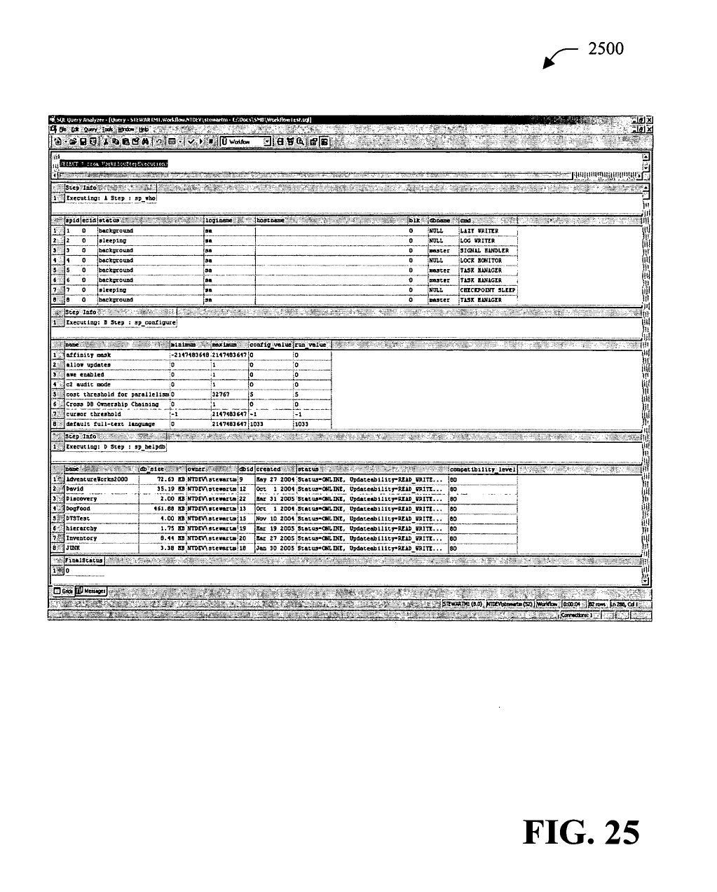

An example output of the execution of this workflow script is set forth in FIG. 25. Further, an example WMI Inventory Information is attached in Appendix B.

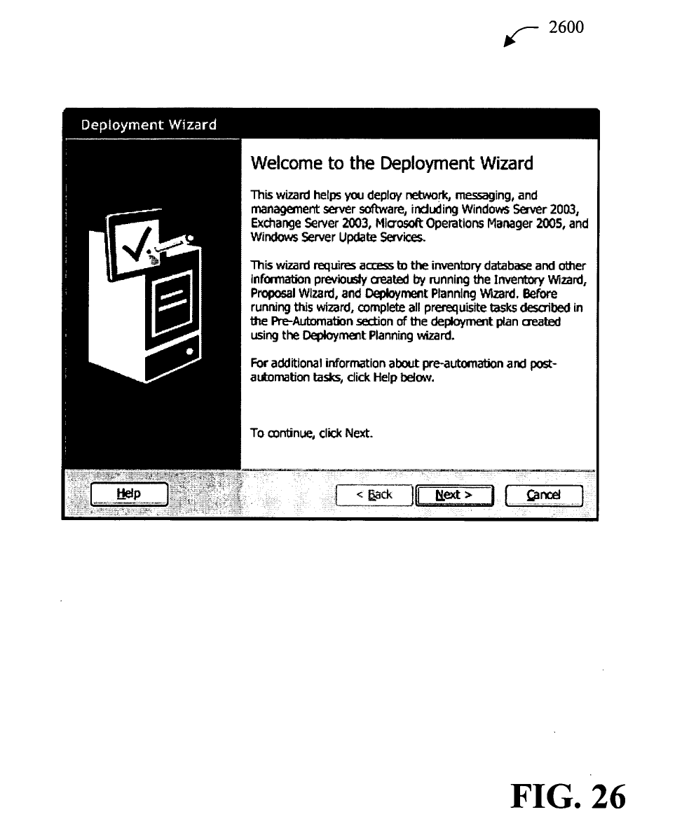

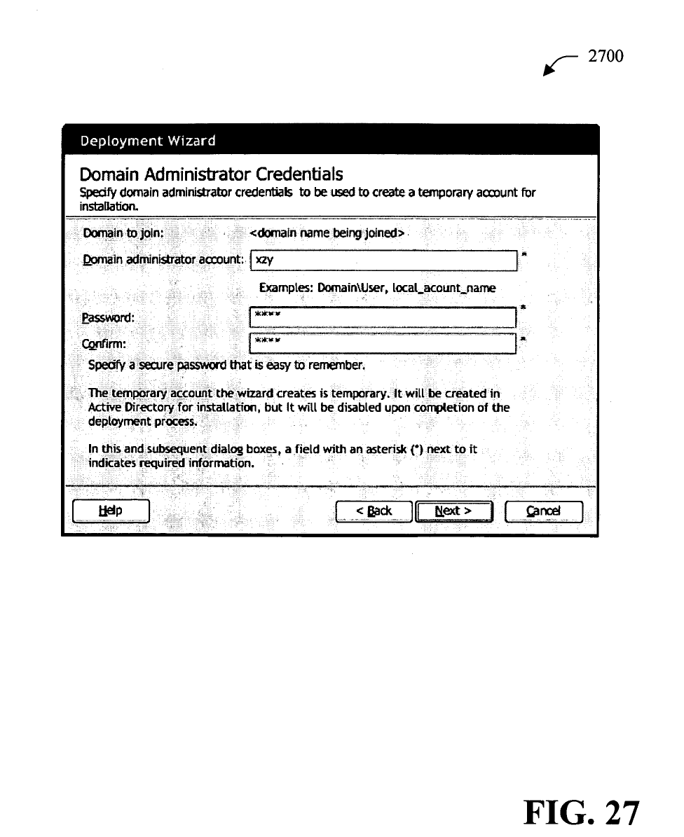

Referring briefly to FIGS. 26-33, screen shots of an exemplary deployment wizard session are illustrated. FIG. 26 is a screen shot of a user interface 2600 of initiation of a deployment wizard. Next, FIG. 27 is a screen shot of a user interface 2700 regarding domain administrator credentials to be used, for example to create a temporary account for installation.

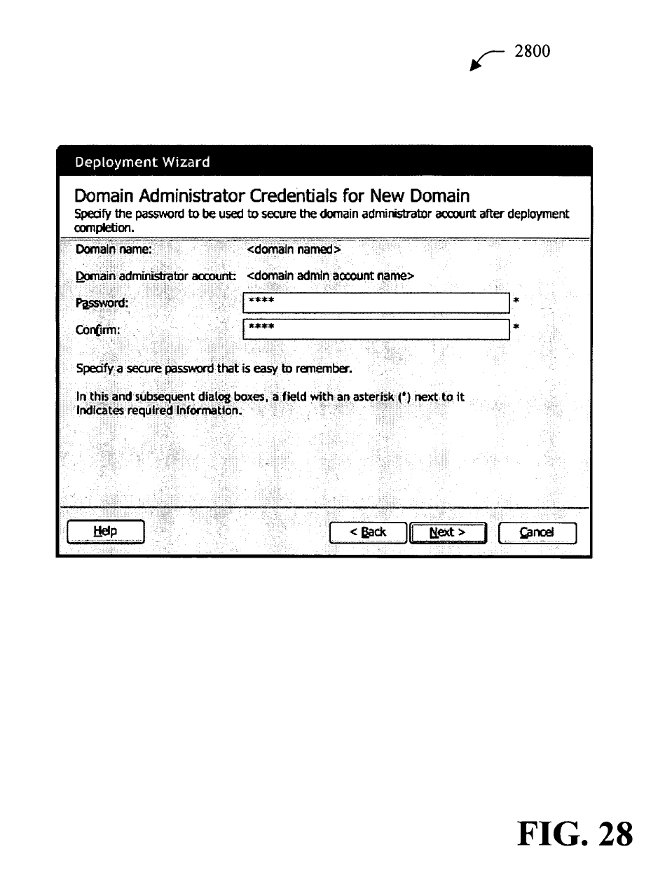

Next, FIG. 28 is a screen shot of a user interface 2800 regarding domain administrator credentials for a new domain. For example, a user can specify the password to be used to secure the domain administrator account after deployment completion.

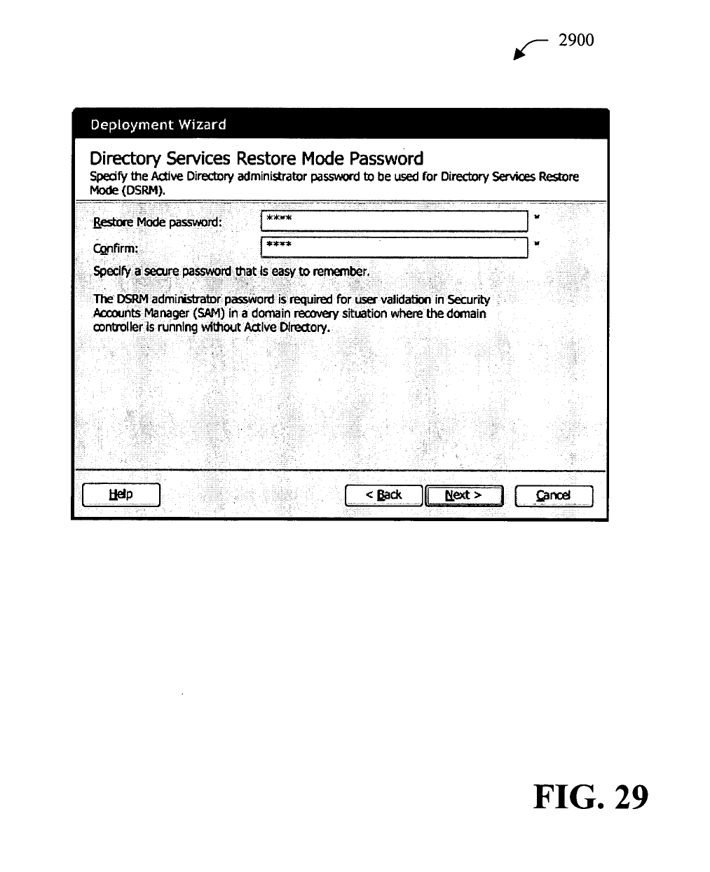

FIG. 29 is a screen shot of a user interface 2900 regarding directory services restore mode password. For example, a user can specify the Active Directory® administrator password to be used for Directory Services Restore Mode (DSRM).

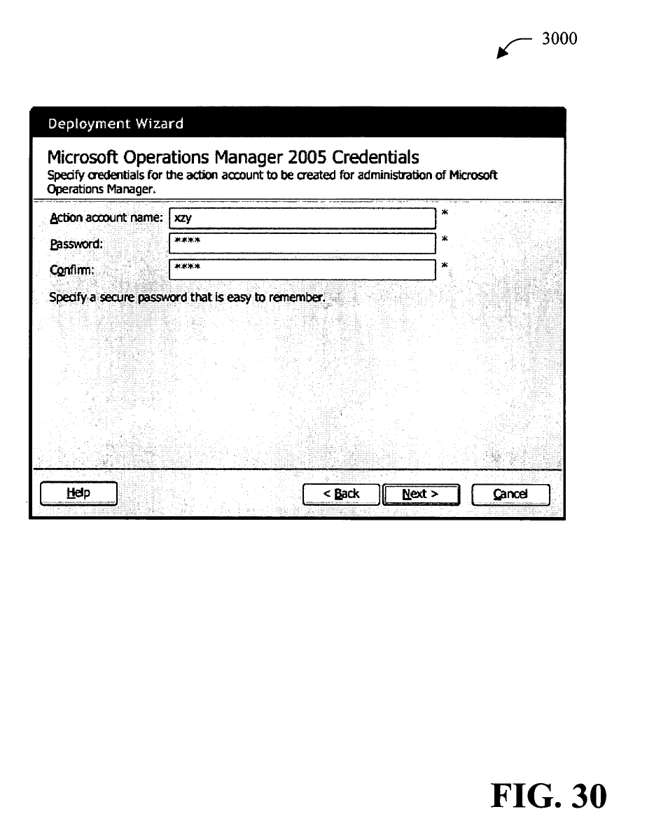

FIG. 30 is a screen shot of a user interface 3000 facilitating entry of operations manager credentials. For example, a user can specify credentials for the action account to be created for administration of Operations Manager.

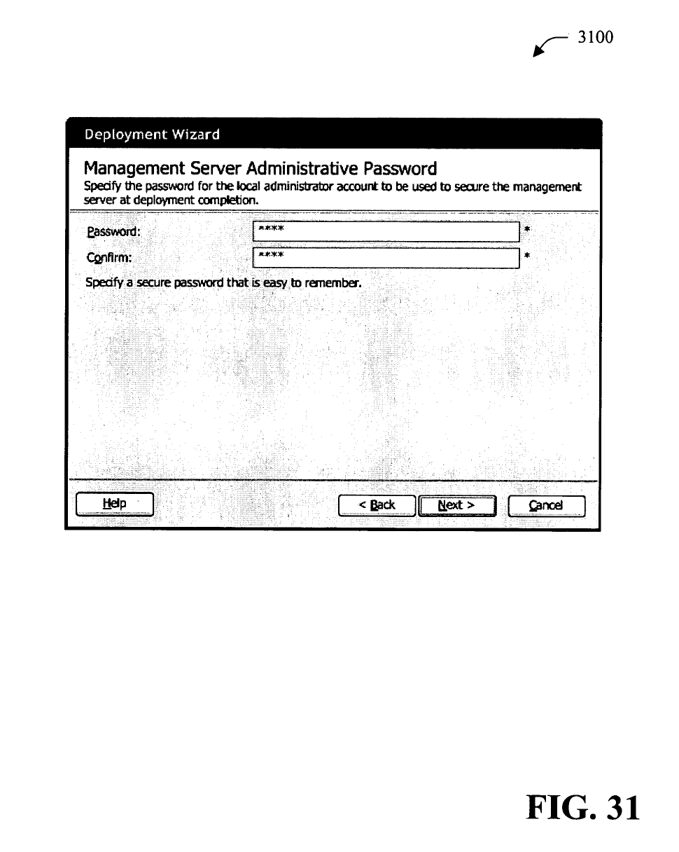

FIG. 31 is a screen shot of a user interface 3100 regarding Management Server Administrative Password. A user can specify the password for the local administrator account to be used to secure the management server at deployment completion.

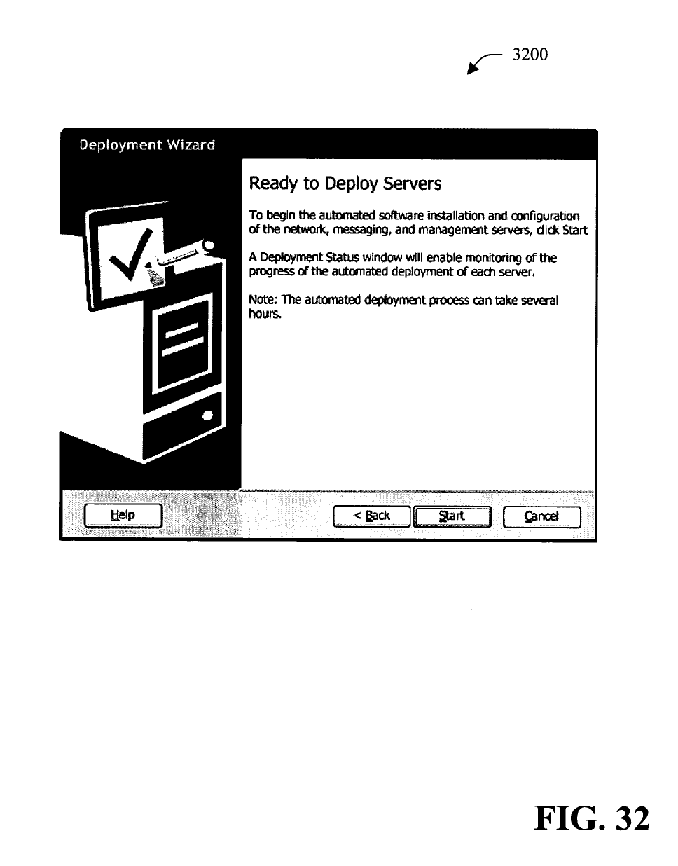

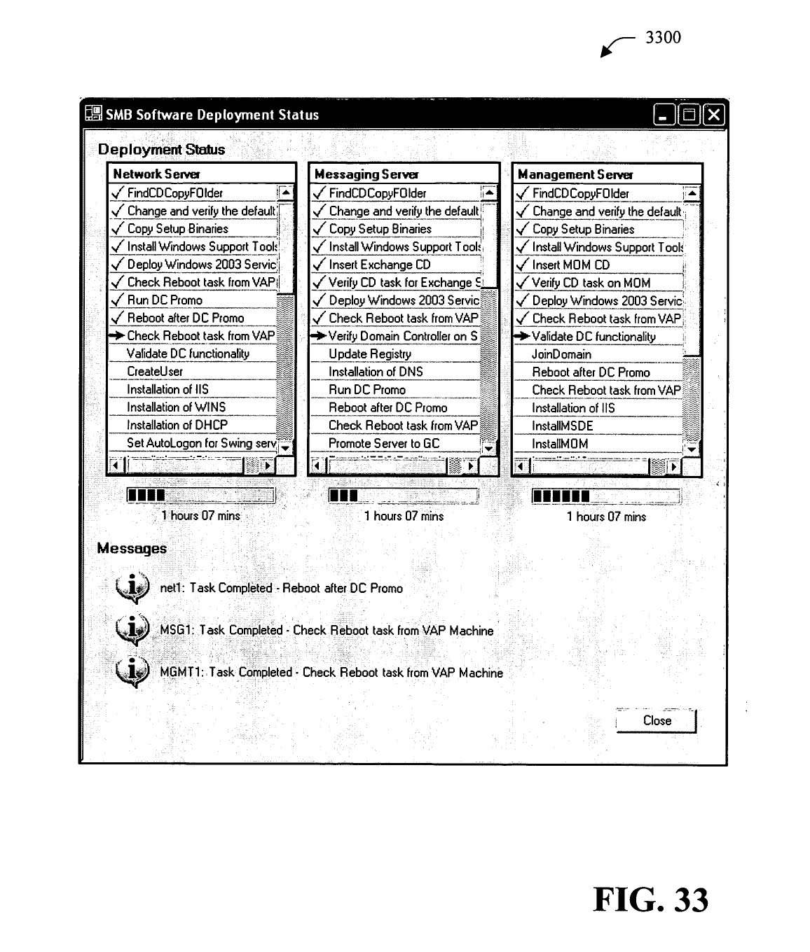

FIG. 32 is a screen shot of a user interface 3200 indicating that the system is ready to deploy servers. FIG. 33 is a screen shot of a user interface 3300 that facilitates communication with a user during the deployment process.

An exemplary deployment plan is included in Appendix C and is part of this specification.

It is to be appreciated that the system 100, the inventory collection component 110, the inventory data store 120, the inventory wizard 130, the inventory collector(s) 210, the system 1100, the project proposal wizard 1110, the detailed project plan 1120, the diagram(s) 1130, the check list(s) 1140, the automated deployment component 1150, the server reporting tool 1160, the compatibility component 1170 and/or the planning wizard 1180 can be computer components as that term is defined herein.

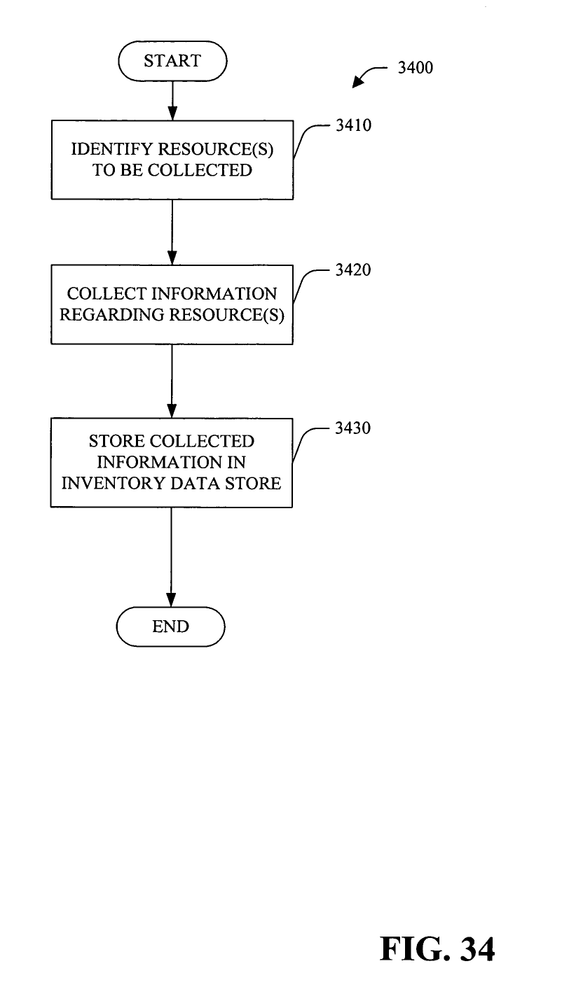

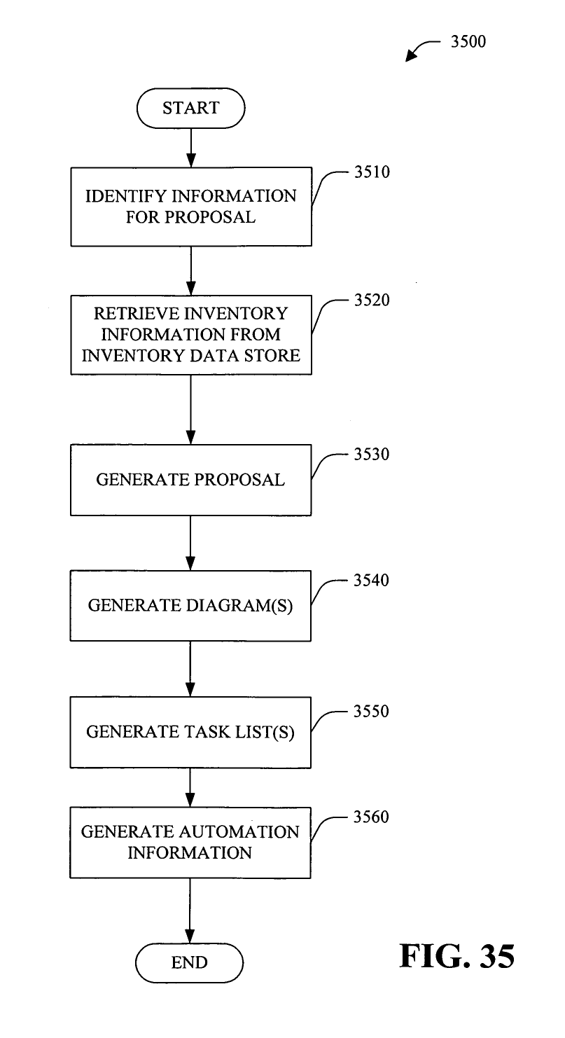

Turning briefly to FIGS. 34 and 35, methodologies that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 34, a method of collecting inventory information 3400 is illustrated. At 3410, resource(s) to be collected are identified (e.g., based on user supplied criteria via an inventory wizard 130). At 3420, information regarding resource(s) is collected (e.g., via an inventory collection component 110). Next, at 3430, the collected information is stored in an inventory data store (e.g., inventory data store 120).

Turning to FIG. 27, a method of generating proposal information 2700 is illustrated. At 2710, information to be employed to generate a proposal is received (e.g., via a project proposal wizard 1110). At 2720, inventory information is retrieved from an inventory data store (e.g., inventory data store 120).

At 3530, the proposal is generated. At 3540, diagram(s) are automatically generated (e.g., “as-is” diagram and/or proposed diagram). At 3550, task list(s) are generated. At 3560, automation information is generated (e.g., workflow process tables populated and/or script(s) created). For example, workflow automation information can be generated which is stored in the inventory data store (e.g., the workflow automation information describes task sequencing, tasks and steps associated with tasks). The workflow automation information can include precedence constraints, a precedence constraint defines a state required for a particular step to execute, the particular step executed only after all of its precedence constraints, if any, have been satisfied, as discussed previously.

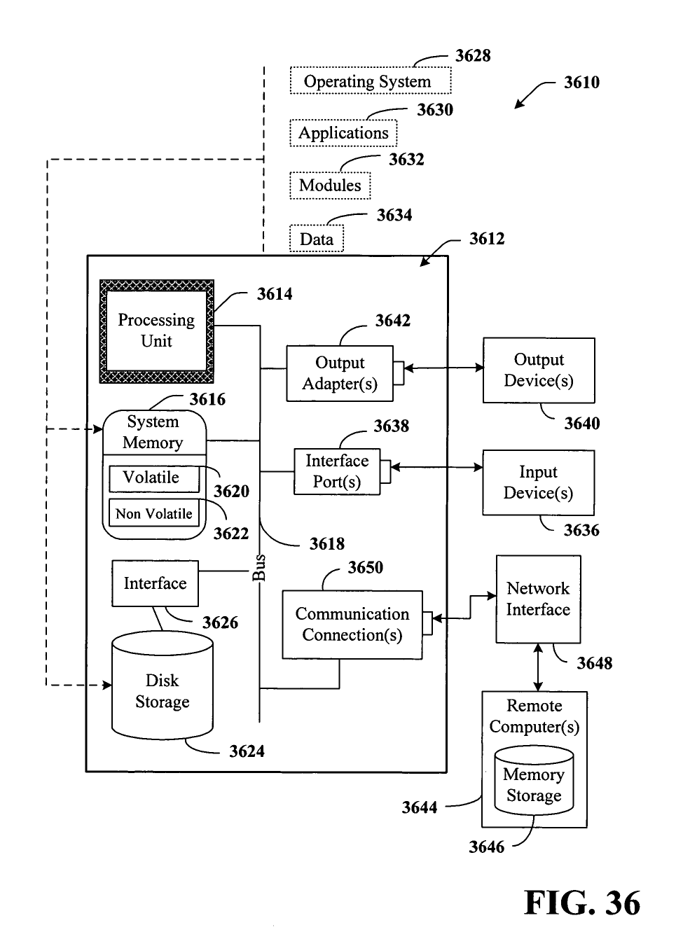

In order to provide additional context for various aspects of the claimed subject matter, FIG. 36 and the following discussion are intended to provide a brief, general description of a suitable operating environment 3610. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 3610 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 36, an exemplary environment 3610 includes a computer 3612. The computer 3612 includes a processing unit 3614, a system memory 3616, and a system bus 3618. The system bus 3618 couples system components including, but not limited to, the system memory 3616 to the processing unit 3614. The processing unit 3614 can be any of various available processors. Dual microprocessors and other multiprocessor architectures also can be employed as the processing unit 3614.

The system bus 3618 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 3616 includes volatile memory 3620 and nonvolatile memory 3622. The basic input/output system (BIOS), containing the basic routines to transfer information between elements within the computer 3612, such as during start-up, is stored in nonvolatile memory 3622. By way of illustration, and not limitation, nonvolatile memory 3622 can include read only memory (ROM), programmable ROM (PROM), electrically programmable ROM (EPROM), electrically erasable ROM (EEPROM), or flash memory. Volatile memory 3620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 3612 also includes removable/nonremovable, volatile/nonvolatile computer storage media. FIG. 36 illustrates, for example a disk storage 3624. Disk storage 3624 includes, but is not limited to, devices like a magnetic disk drive, floppy disk drive, tape drive, Jaz drive, Zip drive, LS-100 drive, flash memory card, or memory stick. In addition, disk storage 3624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 3624 to the system bus 3618, a removable or non-removable interface is typically used such as interface 3626.

It is to be appreciated that FIG. 36 describes software that acts as an intermediary between users and the basic computer resources described in suitable operating environment 3610. Such software includes an operating system 3628. Operating system 3628, which can be stored on disk storage 3624, acts to control and allocate resources of the computer system 3612. System applications 3630 take advantage of the management of resources by operating system 3628 through program modules 3632 and program data 3634 stored either in system memory 3616 or on disk storage 3624. It is to be appreciated that the claimed subject matter can be implemented with various operating systems or combinations of operating systems.

A user enters commands or information into the computer 3612 through input device(s) 3636. Input devices 3636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 3614 through the system bus 3618 via interface port(s) 3638. Interface port(s) 3638 include, for example, a serial port, a parallel port, a game port, and a universal serial bus (USB). Output device(s) 3640 use some of the same type of ports as input device(s) 3636. Thus, for example, a USB port may be used to provide input to computer 3612, and to output information from computer 3612 to an output device 3640. Output adapter 3642 is provided to illustrate that there are some output devices 3640 like monitors, speakers, and printers among other output devices 3640 that require special adapters. The output adapters 3642 include, by way of illustration and not limitation, video and sound cards that provide a means of connection between the output device 3640 and the system bus 3618. It should be noted that other devices and/or systems of devices provide both input and output capabilities such as remote computer(s) 3644.

Computer 3612 can operate in a networked environment using logical connections to one or more remote computers, such as remote computer(s) 3644. The remote computer(s) 3644 can be a personal computer, a server, a router, a network PC, a workstation, a microprocessor based appliance, a peer device or other common network node and the like, and typically includes many or all of the elements described relative to computer 3612. For purposes of brevity, only a memory storage device 3646 is illustrated with remote computer(s) 3644. Remote computer(s) 3644 is logically connected to computer 3612 through a network interface 3648 and then physically connected via communication connection 3650. Network interface 3648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 3650 refers to the hardware/software employed to connect the network interface 3648 to the bus 3618. While communication connection 3650 is shown for illustrative clarity inside computer 3612, it can also be external to computer 3612. The hardware/software necessary for connection to the network interface 3648 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented automated network assessment system comprising the following computer executable components:
an inventory data store that stores information regarding hardware component(s) and/or software component(s) of a computer network; and, an inventory collection component that automatically discovers hardware component(s) and/or software component(s) and stores information regarding the discovered hardware component(s) and/or software component(s) in the inventory data store.

2. The system of claim 1, the inventory collection component comprising one or more inventory collectors, each inventory collector discovers detail information associated with hardware component(s) and/or software component(s) in a particular manner.

3. The system of claim 2, at least one inventory collector associated with Win32®, Windows® Management Information (WMI), Active Directory® (AD), LanManager API, Service Control Manager and/or Simple Network Management Protocol (SNMP)),

4. The system of claim 1, the inventory collection component remotely connected to computers using remote procedure calls.

5. The system of claim 1, the inventory collection component remotely connected to computers using distributed component object model (DCOM).

6. The system of claim 1, the inventory collection component remotely connected to computers using Lightweight Directory Access Protocol (LDAP).

7. The system of claim 1, further comprising a legacy inventory collector installed on a particular computer on the network.

8. The system of claim 1, further comprising an inventory wizard employed to specify information a user desires the system to collect.

9. A computer-implemented automated network deployment system comprising the following computer executable components:
an inventory data store that stores information regarding hardware component(s) and/or software component(s) of a computer network; and, a project proposal wizard employed to facilitate generation of a detailed proposal based, at least in part, upon information stored in the inventory data store.

10. The system of claim 9, the project proposal wizard generates a detailed project plan that includes a list of software to be installed and configurations selected.

11. The system of claim 9, the project proposal wizard automatically generates a diagram of a current state of the network and/or a proposed state of the network.

12. The system of claim 9, the project proposal wizard automatically generates a checklist that provides details of an upgrade/migration plan that describes the location of a service and one or more step required to complete the upgrade/migration.

13. The system of claim 9, the project proposal wizard automatically generates workflow automation information which is stored in the inventory data store, the workflow automation information describes task sequencing, tasks and steps associated with tasks.

14. The system of claim 13, the workflow automation information further includes precedence constraints, a precedence constraint defines a state required for a particular step to execute, the particular step executed only after all of its precedence constraints, if any, have been satisfied.

15. The system of claim 9, further comprising a compatibility component that identifies a known hardware and/or software compatibility issue associated with the network and/or a computer on the network.

16. The system of claim 9, the project proposal wizard automatically generates scripts to be employed in configuration of a software application and/or an operating system.

17. A computer-implemented method of generating proposal information comprising the following computer executable acts:
receiving information to be employed in generating a proposal;
retrieving inventory information from an inventory data store; and
generating the proposal based, at least in part, upon the information to be employed in generating the proposal and the retrieved inventory information.

18. The method of claim 17, further comprising at least one of the following computer executable acts:
generating a task list based, at least in part, upon the information to be employed in generating the proposal and the retrieved inventory information; and,
generating automation information based, at least in part, upon the information to be employed in generating the proposal and the retrieved inventory information.

19. The method of claim 17, further comprising generating workflow automation information which is stored in the inventory data store, the workflow automation information describes task sequencing, tasks and steps associated with tasks.

20. The method of claim 19, the workflow automation information further includes precedence constraints, a precedence constraint defines a state required for a particular step to execute, the particular step executed only after all of its precedence constraints, if any, have been satisfied.
